(19) United States
(12) Patent Application Publication
(10) Pub. No.: US 2023/0071667 A1
(43) Pub. Date: Mar. 9, 2023

(54) NEURAL NETWORK INPUT EMBEDDING INCLUDING A POSITIONAL EMBEDDING AND A TEMPORAL EMBEDDING FOR TIME-SERIES DATA PREDICTION

(71) Applicant: SparkCognition, Inc., Austin, TX (US)

(72) Inventors: Tyler S. McDonnell, Austin, TX (US); Jimmie Goode, Austin, TX (US); William Jurayj, Brookline, MA (US); Nikolai Warner, Atlanta, GA (US); Udaivir Yadav, Austin, TX (US)

(21) Appl. No.: 17/930,225

(22) Filed: Sep. 7, 2022

Related U.S. Application Data
(60) Provisional application No. 63/241,919, filed on Sep. 8, 2021.
(60) Provisional application No. 63/241,913, filed on Sep. 8, 2021.
(60) Provisional application No. 63/241,911, filed on Sep. 8, 2021.

(51) Int. Cl. G06N 3/04

(52) U.S. Cl. CPC G06N 3/049

(57) ABSTRACT

A device includes one or more processors configured to process first input time-series data associated with a first time range using an embedding generator to generate an input embedding. The input embedding includes a positional embedding and a temporal embedding. The positional embedding indicates a position of an input value within the first input time-series data. The temporal embedding indicates that a first time associated with the input value is included in a particular day, a particular week, a particular month, a particular year, a particular holiday, or a combination thereof. The processors are configured to process the input embedding using a predictor to generate second predicted time-series data associated with a second time range. The second time range is subsequent to at least a portion of the first time range. The processors are configured to provide, to a second device, an output based on the second predicted time-series data.

### CROSS-REFERENCE TO RELATED APPLICATION

The present application claims priority from U.S. Provisional Patent Application No. 63/241,911 filed Sep. 8, 2021, U.S. Provisional Patent Application No. 63/241,913 filed Sep. 8, 2021, and U.S. Provisional Patent Application No. 63/241,919 filed Sep. 8, 2021, the content of each of which is incorporated by reference herein in its entirety.

### FIELD

The present disclosure is generally related to using a neural network input embedding that includes a positional embedding and a temporal embedding to predict time-series data.

### BACKGROUND

Equipment, such as machinery or other devices, is commonly monitored via multiple sensors that generate time-series sensor data indicative of operation of the equipment. An anomalous operating state of the equipment may be detected via analysis of the sensor data and an alert generated to indicate the anomalous operating state. However, detecting the anomalous operating state after it has occurred can result in expensive downtime while remedial actions are taken.

### SUMMARY

In some aspects, a device includes one or more processors configured to process first input time-series data associated with a first time range using an embedding generator to generate an input embedding. The input embedding includes a positional embedding and a temporal embedding. The positional embedding indicates a position of an input value of the first input time-series data within the first input time-series data. The temporal embedding indicates that a first time associated with the input value is included in at least one of a particular day, a particular week, a particular month, a particular year, or a particular holiday. The one or more processors are also configured to process the input embedding using a predictor to generate second predicted time-series data associated with a second time range. The second time range is subsequent to at least a portion of the first time range. The one or more processors are further configured to provide an output to a second device. The output is based on the second predicted time-series data.

In some aspects, a method includes processing first input time-series data associated with a first time range using an embedding generator to generate an input embedding. The input embedding including a positional embedding and a temporal embedding. The positional embedding indicates a position of an input value of the first input time-series data within the first input time-series data. The temporal embedding indicates that a first time associated with the input value is included in at least one of a particular day, a particular week, a particular month, a particular year, or a particular holiday. The method also includes processing the input embedding using a predictor to generate second predicted time-series data associated with a second time range. The method further includes providing an output to a second device, the output based on the second predicted time-series data.

In some aspects, a non-transitory computer-readable medium stores instructions. The instructions, when executed by one or more processors, cause the one or more processors to process first input time-series data associated with a first time range using an embedding generator to generate an input embedding. The input embedding including a positional embedding and a temporal embedding. The positional embedding indicates a position of an input value of the first input time-series data within the first input time-series data. The temporal embedding indicates that a first time associated with the input value is included in at least one of a particular day, a particular week, a particular month, a particular year, or a particular holiday. The instructions, when executed by the one or more processors, also cause the one or more processors to process the input embedding using a predictor to generate second predicted time-series data associated with a second time range. The instructions, when executed by the one or more processors, further cause the one or more processors to provide an output to a second device. The output is based on the second predicted time-series data.

### BRIEF DESCRIPTION OF THE DRAWINGS

FIG. 1 illustrates a block diagram of a system configured to use a neural network input embedding that includes a positional embedding and a temporal embedding to predict time-series data, in accordance with some examples of the present disclosure.

FIG. 2 illustrates a diagram corresponding to operations that may be performed by one or more pre-processing layers of the system of FIG. 1, in accordance with some examples of the present disclosure.

FIG. 3 illustrates a diagram corresponding to operations that may be performed during batch normalization by the system of FIG. 1, in accordance with some examples of the present disclosure.

FIG. 4 illustrates a diagram corresponding to operations that may be performed by one or more spatial attention layers of the system of FIG. 1, in accordance with some examples of the present disclosure.

FIG. 5 illustrates a diagram corresponding to operations that may be performed by one or more convolution layers of the system of FIG. 1, in accordance with some examples of the present disclosure.

FIG. 6A illustrates a diagram corresponding to operations that may be performed by an embedding generator of the system of FIG. 1, in accordance with a particular implementation of the present disclosure.

FIG. 6B illustrates a diagram corresponding to operations that may be performed by an embedding generator of the system of FIG. 1, in accordance with another particular implementation of the present disclosure.

FIG. 7 illustrates a diagram of an example of an implementation of a time-series data predictor of the system of FIG. 1, in accordance with some examples of the present disclosure.

FIG. 8 illustrates a diagram of an example of another implementation of the time-series data predictor of the system of FIG. 1, in accordance with some examples of the present disclosure.

FIG. 9 illustrates a particular implementation of a system operable to detect a mode change using the time-series data predictor of FIG. 1, in accordance with some examples of the present disclosure.

FIG. 10 illustrates another implementation of a system operable to detect a mode change using the time-series data predictor of FIG. 1, in accordance with some examples of the present disclosure.

FIG. 11 illustrates another implementation of a system operable to detect a mode change using the time-series data predictor of FIG. 1, in accordance with some examples of the present disclosure.

FIG. 12 is a flow chart of an example of a method of using a neural network input embedding including a positional embedding and a temporal embedding for time-series data prediction.

FIG. 13 illustrates comparison of input time-series data and predicted time-series data as the time-series data predictor is trained over time.

### DETAILED DESCRIPTION

Systems and methods are described that use a transformer neural network for time-series data prediction. The transformer neural network can predict time-series data based on historical time-series data (e.g., historical sensor data). For example, the transformer neural network processes time-series input data (e.g., sensor data) associated with a first time range (e.g., an Mth time range) to generate predicted second time-series data associated with a second time range (e.g., an Nth time range).

In some examples, a change in operating mode can be detected when the predicted time-series data does not match actual time-series input data for the same time range. For example, when second time-series input data for the second time range (e.g., the Nth time range) is received, the predicted second time-series data is compared to the second time-series input data to determine a risk score. In some examples, a change in operating mode is detected if the risk score is higher than a threshold risk score. The change in operating mode may occur due to repairs and system reboots and the resulting changes in sensor data distributions. In some examples, the change in operating mode can predict a future occurrence of an anomalous operating state. The prediction can enable troubleshooting to prevent or reduce the impact of the occurrence of the anomalous operating state.

The transformer neural network can process multi-variant input data to output predicted multi-variant data. For example, the transformer neural network can process time-series input data corresponding to multiple sensors to generate the predicted second time-series data for the multiple sensors, resulting in more accurate predictions as compared to individual prediction models for each sensor type. The transformer neural network can include one or more spatial attention layers to account for spatial dependencies (e.g., across the sensors) and one or more convolution layers to account for temporal dependencies (e.g., across the time-ranges), resulting in more accurate predictions.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, spatial attention layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

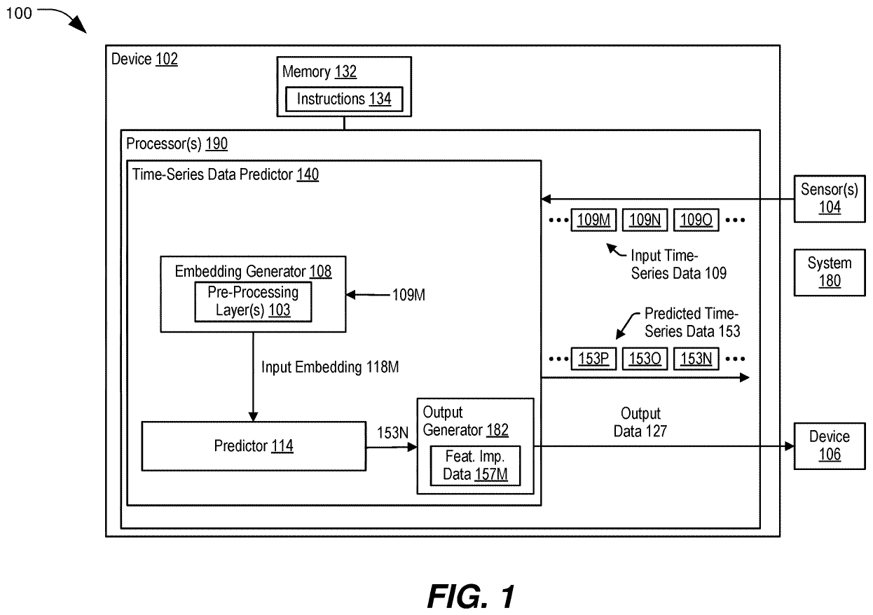

Referring to FIG. 1, a system operable to use a neural network input embedding including a positional embedding and a temporal embedding to predict time-series data is shown and generally designated 100. The system 100 includes a device 102 configured to be coupled to one or more sensors 104. The one or more sensors 104 are depicted as external to the device 102 as an illustrative example. In some examples, at least one of the one or more sensors 104 may be integrated in the device 102. In a particular aspect, the one or more sensors 104 include at least one of an image sensor, a temperature sensor, a pressure sensor, a position sensor, a location sensor, a vibration sensor, or an audio sensor.

In some implementations, the one or more sensors 104 are configured to monitor a system 180, such as equipment, a vehicle, a building, etc. In some implementations, the system 180 may include one or more monitored devices. The one or more sensors 104 are depicted as external to the system 180 as an illustrative example. In some examples, at least one of the one or more sensors 104 may be coupled to or integrated in the system 180. The one or more sensors 104 are configured to provide input time-series data 109 to the device 102. For example, the input time-series data 109 is based on (e.g., includes) sensor values generated by the one or more sensors 104.

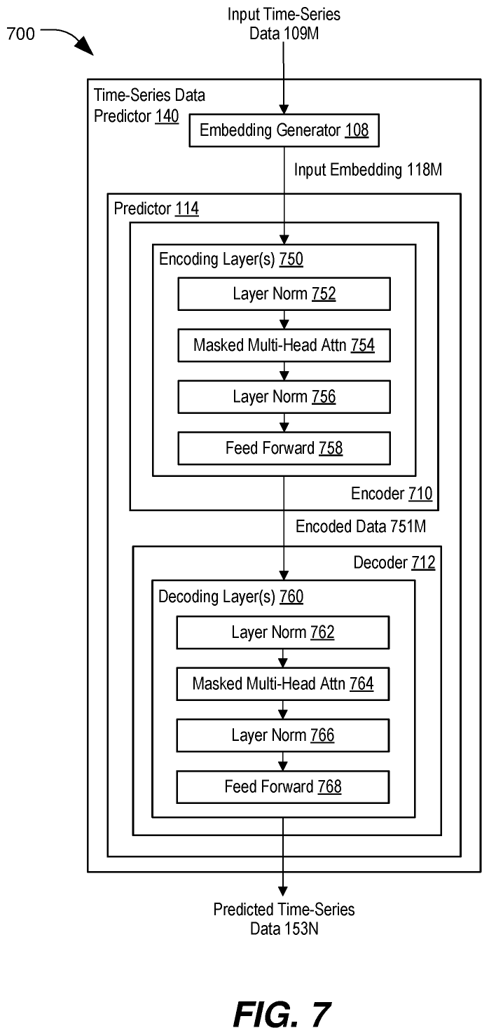

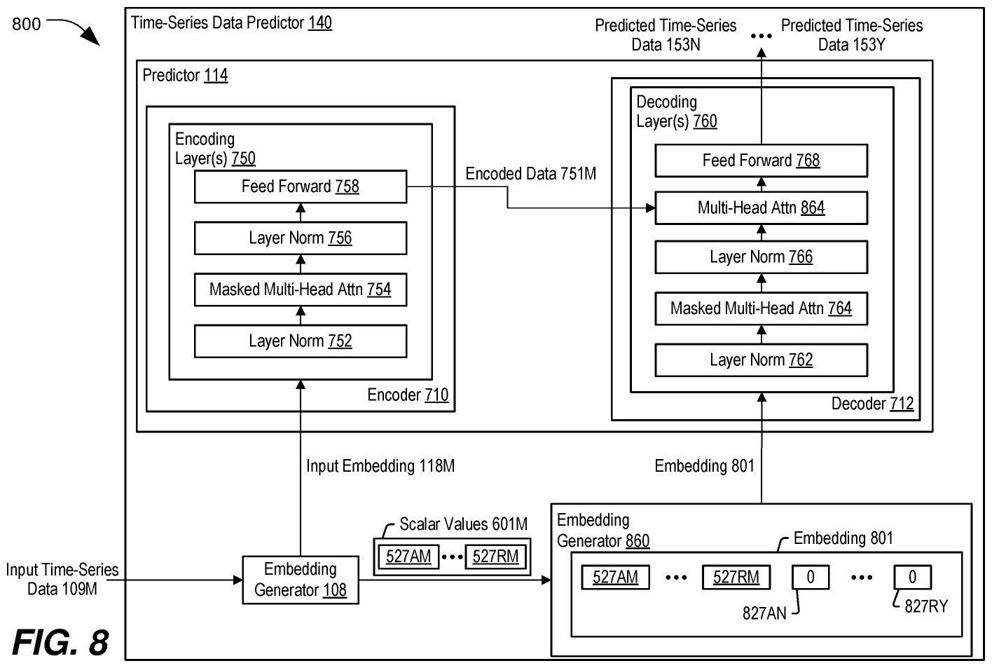

The device 102 includes one or more processors 190 coupled to a memory 132. The one or more processors 190 include a time-series data predictor 140 that is configured to use a predictor 114 to process the input time-series data 109 to generate predicted time-series data 153, as further described with reference to FIGS. 7-8. In some implementations, the time-series data predictor 140 includes an output generator 182 coupled to the predictor 114.

The time-series data predictor 140 includes an embedding generator 108. In some implementations, the embedding generator 108 is coupled to the predictor 114. In other implementations, the predictor 114 includes the embedding generator 108. The embedding generator 108 includes one or more pre-processing layers 103 configured to process the input time-series data 109 to generate an input embedding 118.

In some implementations, the memory 132 includes volatile memory devices, non-volatile memory devices, or both, such as one or more hard drives, solid-state storage devices (e.g., flash memory, magnetic memory, or phase change memory), a random access memory (RAM), a read-only memory (ROM), one or more other types of storage devices, or any combination thereof. The memory 132 stores data and instructions 134 (e.g., computer code) that are executable by the one or more processors 190. For example, the instructions 134 are executable by the one or more processors 190 to initiate, perform, or control various operations of the time-series data predictor 140.

In some implementations, the one or more processors 190 include one or more single-core or multi-core processing units, one or more digital signal processors (DSPs), one or more graphics processing units (GPUs), or any combination thereof. The one or more processors 190 are configured to access data and instructions from the memory 132 and to perform various operations associated with the time-series data predictor 140.

The device 102 is configured to be coupled to a device 106. In some aspects, the device 106 includes a display device, a network device, a storage device, a controller of the system 180, or a combination thereof. The output generator 182 is configured to generate output data 127 based at least in part on the predicted time-series data 153, and to provide the output data 127 to the device 106.

During operation, the time-series data predictor 140 receives input time-series data 109M from the one or more sensors 104. For example, the one or more sensors 104 provide the input time-series data 109M associated with an Mth time range (e.g., 12:00 PM-12:30 PM on Jan. 1, 2021) to the device 102. The input time-series data 109M includes a plurality of sensor values generated by the one or more sensors 104. In some aspects, each of the plurality of sensor values can be referred to as a feature value of a feature (e.g., a sensor data type). A sensor data type can correspond to a sensor, a type of sensor data, or both. As an example, the input time-series data 109M may include one or more temperature sensor values generated by a temperature sensor, one or more pressure sensor values generated by a pressure sensor, one or more additional sensor values generated by one or more additional sensors, or a combination thereof. In this example, temperature can be referred to as a first feature and pressure can be referred to as a second feature. The one or more temperature sensor values can be referred to as feature values of the first feature, and the one or more pressure sensor values can be referred to as feature values of the second feature.

In a particular implementation, the input time-series data 109M is generated by the one or more sensors 104 during the Mth time range (e.g., 12:00 PM-12:30 PM on Jan. 1, 2021). For example, each sensor value of the input time-series data 109M is associated with a generation timestamp indicating a time that is included in the Mth time range. In this implementation, one or more values of the input time-series data 109M could be received by the device 102 during or after the Mth time range. In a particular implementation, the device 102 receives the input time-series data 109M from the one or more sensors 104 during the Mth time range. For example, each sensor value of the input time-series data 109M is associated with a receipt timestamp indicating a time that is included in the Mth time range. In this implementation, one or more values of the input time-series data 109M could be generated by the one or more sensors 104 prior to or during the Mth time range.

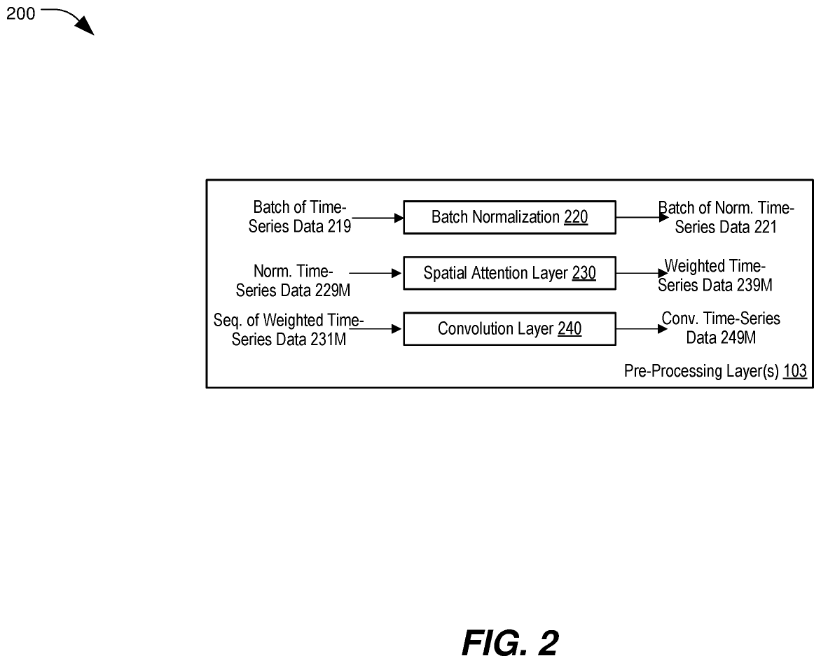

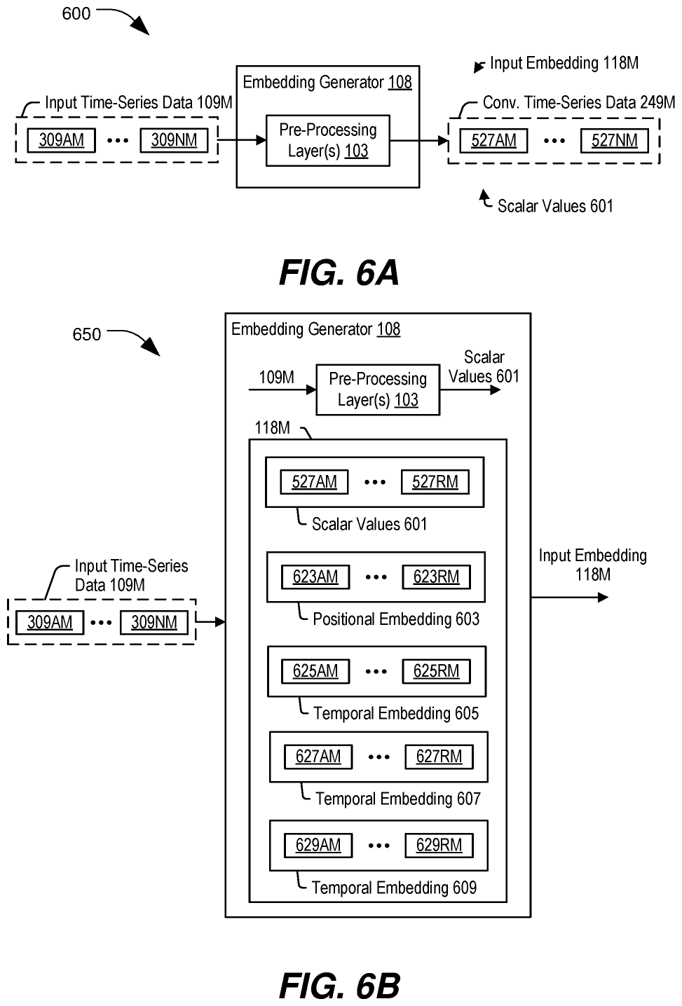

The one or more pre-processing layers 103 of the embedding generator 108 process the input time-series data 109M to generate an input embedding 118M, as further described with reference to FIGS. 2-6B. For example, the one or more pre-processing layers 103 use batch normalization, spatial attention, convolution, etc. to generate the input embedding 118M. In some implementations, the embedding generator 108 generates the input embedding 118M including positional embedding, temporal embedding, or both, as further described with reference to FIG. 6B.

The predictor 114 processes the input embedding 118M to generate predicted time-series data 153N associated with an Nth time range, as further described with reference to FIGS. 7-8. The Mth time range may start at a first start time (e.g., 12:00 PM on Jan. 1, 2021) and end at a first end time (e.g., 12:30 PM on Jan. 1, 2021). The Nth time range may start at a second start time and end at a second end time.

As used herein, in some examples, a letter at the end of a reference number indicates an associated time range. For example, “109M” corresponds to the input time-series data associated with the Mth time range. Similarly, other reference numbers with “M” (e.g., 109M and 118M) are associated with the Mth time range. As another example, reference numbers with “N” (e.g., 109N and 153N), “O” (e.g., 109O and 153O), and “P” (e.g., 153P) are associated with the Nth time range, an Oth time range, and a Pth time range, respectively.

The Nth time range is subsequent to at least a portion of the Mth time range. In some aspects, the Nth time range overlaps the Mth time range. For example, the second start time is greater than or equal to the first start time and less than the first end time, and the second end time is greater than the first end time. In some aspects, the Nth time range is subsequent to the Mth time range. For example, the second start time is greater than or equal to the first end time.

The output generator 182 generates output data 127 based on the predicted time-series data 153. For example, the output data 127 includes a graphical or tabular representation of the predicted time-series data 153. In some aspects, the output data 127 includes a graphical user interface (GUI), an alert, or both. The time-series data predictor 140 provides the output data 127 to the device 106.

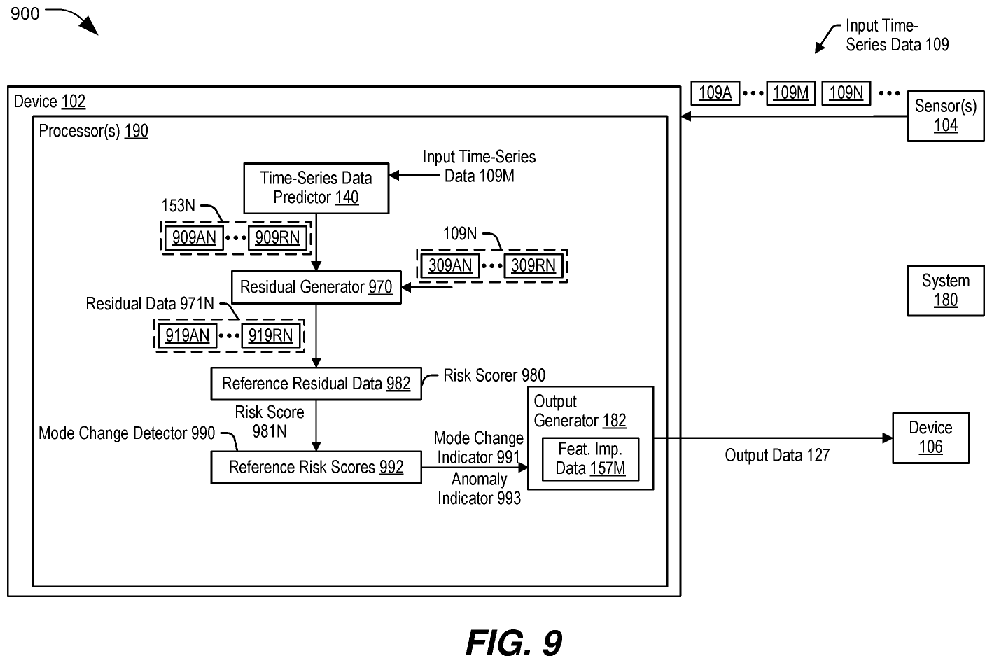

In some implementations, the time-series data predictor 140 receives the input time-series data 109N associated with the Nth time range, and determines whether a change in operating mode is detected based on a comparison of the predicted time-series data 153N (e.g., predicted sensor value(s)) and the input time-series data 109N (e.g., actual sensor value(s)), as further described with reference to FIGS. 9-11. In some implementations, the time-series data predictor 140 determines a likelihood of an anomalous operating state based on whether a change in operating mode of the system 180 is detected.

In some aspects, the time-series data predictor 140 processes the input time-series data 109N associated with the Nth time range to generate predicted time-series data 153O associated with an Oth time range. For example, the time-series data predictor 140 uses the embedding generator 108 to process the input time-series data 109N to generate a second input embedding and uses the predictor 114 to process the second input embedding to generate the predicted time-series data 153O. The Oth time range is at least partially subsequent to the Nth time range.

The output generator 182 generates output data 127 based on the predicted time-series data 153N. For example, the output data 127 includes a representation of the predicted time-series data 153N, an indicator of whether a change in operating mode is detected, an indicator of the likelihood of an anomalous operating state, identifiers of monitored components of the system 180, or a combination thereof. To illustrate, the output generator 182 generates an alert responsive to detecting a change in operating mode and determining that the change in operating mode corresponds to an anomaly.

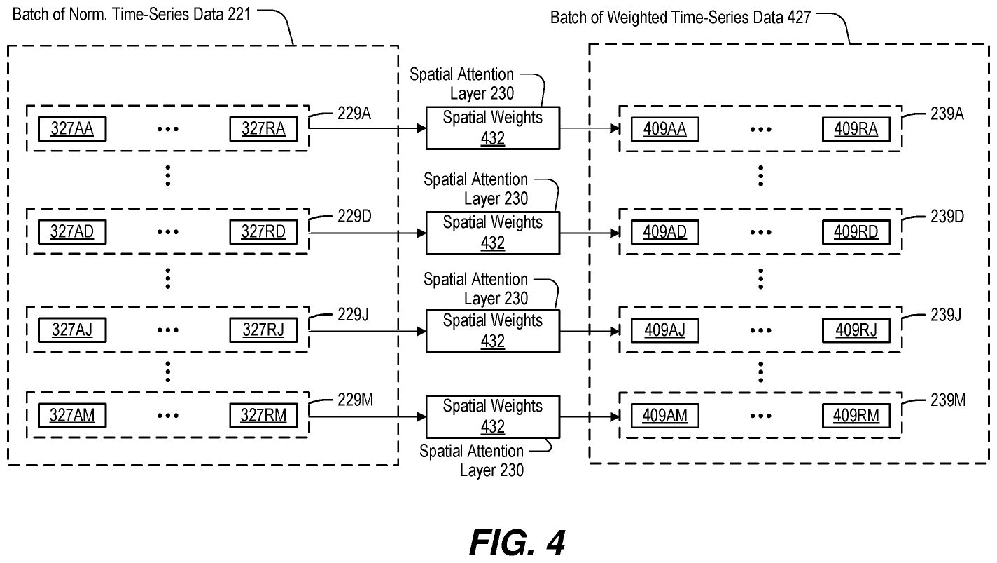

In some implementations, the output data 127 is further based on feature importance data 157M. The feature importance data 157M indicates a relative importance of features of the input time-series data 109 in generating the input embedding 118M that is used to generate the predicted time-series data 153N. For example, the feature importance data 157M indicates that a first feature (e.g., temperature) of the input time-series data 109 has a first importance (e.g., 0.4) and that a second feature (e.g., pressure) of the input time-series data 109 has a second importance (e.g., 0.2) in generating the input embedding 118M. In some implementations, the output generator 182 determines the feature importance data 157M based on spatial weights of a spatial layer of the one or more pre-processing layers 103, as further described with respect to FIG. 4.

In some implementations, the output data 127 indicates the features in order of importance. In some implementations, the output data 127 indicates up to a predetermined count of features with the highest importance (e.g., top 5 most important features) that have the greatest impact in generating the input embedding 118M and the predicted time-series data 153N. In some implementations, the output data 127 is selectively based on the feature importance data 157M. For example, the output generator 182, in response to detecting a change in operating mode and determining that the change in operating mode corresponds to an anomaly, generates the output data 127 based on the feature importance data 157M to indicate the features that were considered most important and had the greatest impact in predicting the anomaly.

The time-series data predictor 140 provides the output data 127 to the device 106. For example, the time-series data predictor 140 provides the output data 127 to a display device, a user device, or both. If an anomalous operating state is predicted, measures can be taken to reduce the impact of the anomalous operating state or to prevent the anomalous operating state from occurring.

Time-series forecasting and anomaly detection can have significant applications in manufacturing, sales, retail, industrial, financial, and other domains. In a particular aspect, the spatio-temporal based architecture of the time-series data predictor 140 offers many commercial advantages including, but not limited to, enabling explainability and feature importance (e.g., the output data 127), independence from future exogenous variables, and faster and efficient training (e.g., a purely feed forward algorithm with any recurrent architectural components). Other advantages can include a single model for multi-target forecasting (e.g., no need for individual models), increased accuracy compared to sequence-to-sequence based models for long-term forecasting, taking advantage of temporal dynamics of exogenous variables in predicting targets, increased accuracy as compared to recurrent neural networks (RNNs) and temporal convolutional networks (TCNs), and fairly accurate predictions based on relatively small datasets.

Although FIG. 1 depicts the device 106 as coupled to the device 102, in other implementations the device 106 is integrated within the device 102. Although the device 102 is illustrated as including the embedding generator 108 and the predictor 114, in other implementations the device 102 may include one of the embedding generator 108 or the predictor 114, and the other of the embedding generator 108 or the predictor 114 may be included in another device coupled to the device 102. Although the device 102 is illustrated as separate from the system 180, in other implementations the system 180 may include the device 102. For example, in some implementations, one of the monitored systems (e.g., the system 180) may include the time-series data predictor 140.

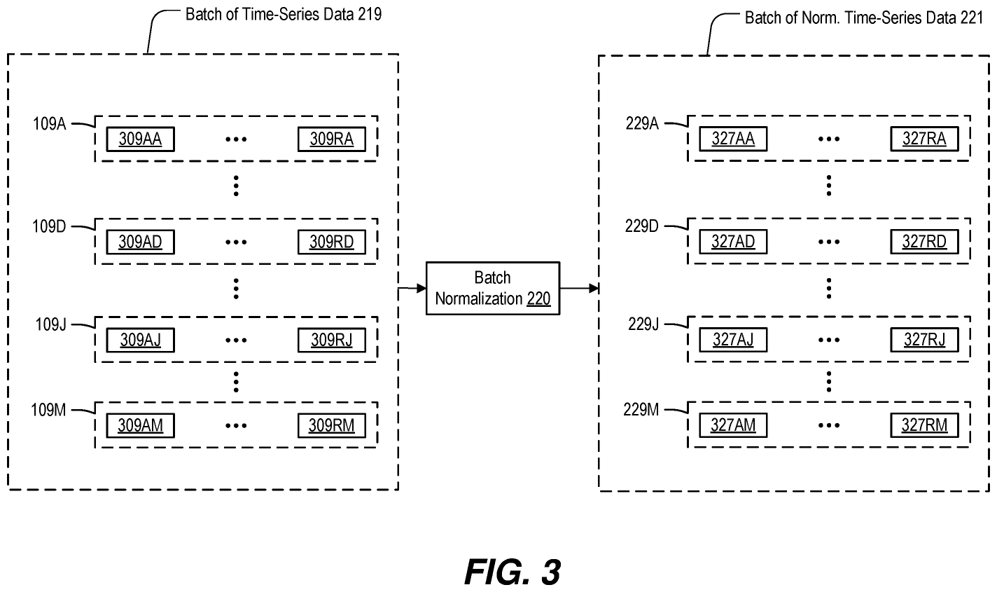

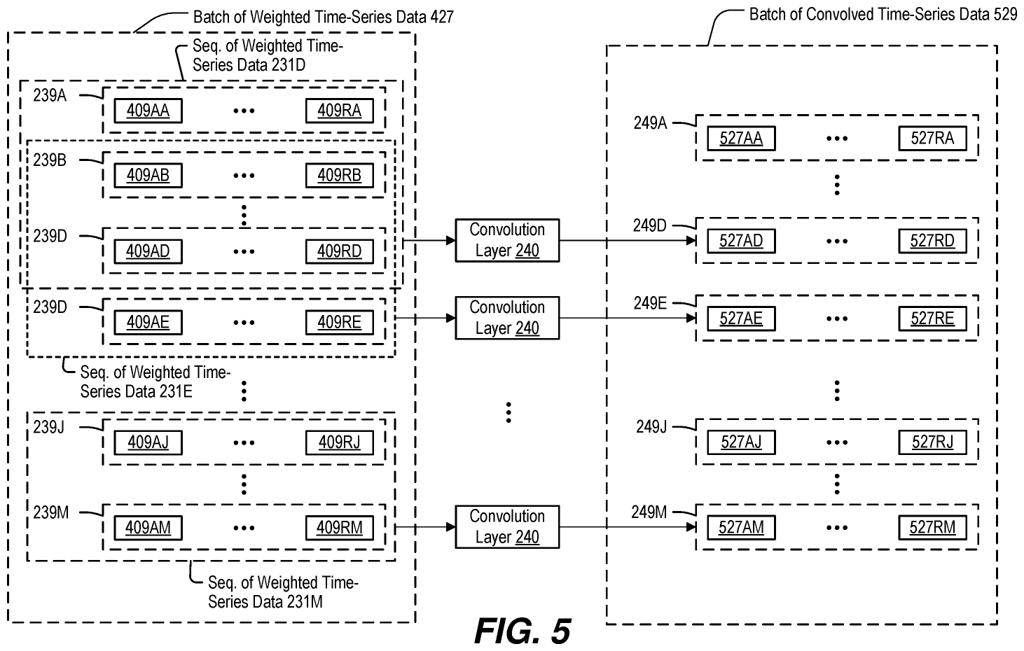

FIGS. 2-5 illustrate operations that may be performed by the one or more pre-processing layers 103. FIG. 2 illustrates that the one or more pre-processing layers 103 include at least one of a batch normalization layer 220, a spatial attention layer 230, or a convolution layer 240. FIG. 3 illustrates operations that may be performed using the batch normalization layer 220. FIG. 4 illustrates operations that may be performed using the spatial attention layer 230. FIG. 5 illustrates operations that may be performed by the convolution layer 240.

Referring to FIG. 2, a diagram 200 illustrates that the one or more pre-processing layers 103 include at least one of the batch normalization layer 220, the spatial attention layer 230, or the convolution layer 240.

The embedding generator 108 of FIG. 1 is configured to process a batch of time-series data 219 using the batch normalization layer 220 to generate a batch of normalized time-series data 221. For example, as illustrated in FIG. 3, the batch normalization layer 220 applies normalization to the batch of time-series data 219 to generate the batch of normalized time-series data 221. The batch of time-series data 219 includes input sensor values 309 received from the one or more sensors 104 of FIG. 1.

The input sensor values 309 can be divided in various groups for analysis. The groups may be overlapping or non-overlapping. In a particular implementation, the input sensor values 309 are grouped into sets of input time-series data 109. Each set of the input time-series data 109 is associated with a particular time range. For example, the batch of time-series data 219 includes the input time-series data 109M associated with the Mth time range (e.g., 12:00 PM-12:30 PM on Jan. 1, 2021).

The input time-series data 109M includes a first subset of the input sensor values 309 that is associated with (e.g., generated or received during) the Mth time range. For example, the input time-series data 109M includes an input sensor value 309AM, one or more additional sensor values, an input sensor value 309RM, or a combination thereof. As used herein, a pair of letters at the end of a reference number corresponding to an input sensor value indicates a corresponding position and an associated time range. The first letter of the pair indicates a position (e.g., a receipt position, a generation position, or both) of the input sensor value within a set of input time-series data and the second letter of the pair indicates an associated time range. For example, “309AM” corresponds to an input sensor value that has an Ath position (e.g., indicated by the first letter “A”) among the input sensor values of the input time-series data 109M and that is associated with the Mth time range (e.g., indicated by the second letter “M”). As another example, “309RM” corresponds to an input sensor value that has an Rth position (e.g., indicated by the first letter “R”) among the input sensor values of the input time-series data 109M and that is associated with the Mth time range (e.g., indicated by the second letter “M”).

In some implementations, a position (e.g., a receipt position) of an input sensor value 309 corresponds to a position of receipt by the time-series data predictor 140 of the input sensor value 309 relative to receipt of other input sensor values 309 of the input time-series data 109. For example, the input sensor value 309AM is the Ath received input sensor value 309 (e.g., as indicated by a receipt timestamp) of the input time-series data 109M. As another example, the input sensor value 309RM is the Rth received input sensor value 309 of the input time-series data 109M.

In some implementations, the position (e.g., a generation position) of the input sensor value 309 corresponds to a position of generation of the input sensor value 309 relative to generation of other input sensor values 309 of the input time-series data 109. For example, the input sensor value 309AM is the Ath generated input sensor value 309 (e.g., as indicated by a generation timestamp) of the input time-series data 109M. As another example, the input sensor value 309RM is the Rth generated input sensor value 309 of the input time-series data 109M.

In some implementations, each input sensor value 309 of the input time-series data 109M is associated with a different sensor of the one or more sensors 104 (e.g., R sensors, where R is a positive integer). As an illustrative non-limiting example, the input time-series data 109M includes a first input sensor value 309AM associated with a first sensor of the one or more sensors 104, an Rth input sensor value 309RM associated with an Rth sensor of the one or more sensors 104, one or more additional sensor values associated with one or more additional sensors, or a combination thereof. In some aspects, the input sensor value 309AM is generated by the first sensor, and is associated with (e.g., received or generated at) a first time (e.g., 12:10 PM on Jan. 1, 2021) included in the Mth time range (e.g., 12:00 PM-12:30 PM on Jan. 1, 2021). In other aspects, the input sensor value 309AM is representative (e.g., mean, median, mode, maximum, or minimum) of multiple first sensor values that are generated by the first sensor and are associated with (e.g., received or generated during) the Mth time range.

In some implementations, multiple sensor values of the input time-series data 109M are associated with a single sensor of the one or more sensors 104 (e.g., fewer than N sensors). As an illustrative non-limiting example, a first sensor of the one or more sensors 104 may generate first sensor values at a first rate (e.g., every 5 minutes), and a second sensor of the one or more sensors 104 may generate second sensor values at a second rate (e.g., every half an hour). In this example, the input time-series data 109M may include a count of first sensor values (e.g., 30/5=6 sensor values) from the first sensor that is based on the first rate (e.g., once every 5 minutes) and a duration (e.g., 30 minutes) of the Mth time range (e.g., 12:00 PM-12:30 PM on Jan. 1, 2021). Similarly, the input time-series data 109M may include a count of second sensor values (e.g., 30/30=1 sensor value) from the second sensor that is based on the second rate (e.g., once every 30 minutes) and the duration (e.g., 30 minutes) of the Mth time range (e.g., 12:00 PM-12:30 PM on Jan. 1, 2021).

In a particular aspect, a first particular subset, a second particular subset, and a third particular subset of the input sensor values 309 of the batch of time-series data 219 are grouped into input time-series data 109A, input time-series data 109D, and input time-series data 109J, respectively. The input time-series data 109A, the input time-series data 109D, and the input time-series data 109J are associated with an Ath time range, a Dth time range, and a Jth time range, respectively. In a particular implementation, each of the Ath time range, the Dth time range, and the Jth time range has a start time that is earlier than the start time of the Mth time range.

Although, each of the input time-series data 109 is illustrated as including the same count of input sensor values 309 (e.g., R input sensor values), in some examples input time-series data 109 associated with a particular time range may include a different count of input sensor values 309 as input time-series data 109 associated with another time range. For example, the input time-series data 109A may include a different count of input sensor values 309 than input sensor values 309 included in the input time-series data 109M. To illustrate, a particular sensor may generate an input sensor value during the Ath time range associated with the input time-series data 109A and not during the Mth time range associated with the input time-series data 109M, or vice versa.

In a particular aspect, the batch normalization layer 220 standardizes the input sensor values 309 of the batch of time-series data 219. For example, the batch normalization layer 220 determines the mean and standard deviation of the input sensor values 309 corresponding to each sensor data type. The batch normalization layer 220 generates, based on the mean and standard deviation for the sensor data types, a batch of normalized time-series data 221 including normalized sensor values 327. A subset of the normalized sensor values 327 corresponding to a single sensor data type has a predetermined mean (e.g., 0) and a predetermined variance (e.g., 1). For example, a first subset of normalized sensor values 327 corresponding to a first data type has a predetermined mean (e.g., 0) and a predetermined variance (e.g., 1), a second subset of normalized sensor values 327 corresponding to a second sensor data type has a predetermined mean (e.g., 0) and a predetermined variance (e.g., 1), and so on.

In a particular aspect, a sensor data type refers to a sensor, a type of sensor data of the sensor, or both. In an illustrative example, the first sensor data type corresponds to sensor values of a first sensor 104, and the second sensor data type corresponds to sensor values of a second sensor 104. The first sensor (e.g., a temperature sensor) may be a different type of sensor than the second sensor (e.g., a pressure sensor). In some aspects, the first sensor (e.g., a first temperature sensor) may be the same type of sensor as the second sensor (e.g., a second temperature sensor).

In a particular aspect, the same sensor may generate multiple types of sensor data. For example, image data from an image sensor may indicate an amount of light exposure (e.g., daylight hours or night hours) of the system 180 and may also indicate a position of a component of the system 180. A first subset of normalized sensor values 327 corresponding to the light exposure data from the image sensor has a predetermined mean (e.g., 0) and a predetermined variance (e.g., 1), and a second subset of normalized sensor values 327 corresponding to the position data has a predetermined mean (e.g., 0) and a predetermined variance (e.g., 1). In some implementations, each of the sensor values of the input time-series data 109 is tagged with a corresponding sensor data type. For example, each of the sensor values is associated with metadata indicating a sensor that generated the sensor value, a type of sensor data of the sensor value, or both.

In an example, the batch normalization layer 220 generates a set of normalized time-series data 229M corresponding to the input time-series data 109M and associated with the Mth time range (e.g., 12:00 PM-12:30 PM on Jan. 1, 2021). The normalized time-series data 229M includes normalized sensor values 327 generated by normalizing the input sensor values 309 of the input time-series data 109M. In a particular aspect, the batch normalization layer 220 determines a mean and standard deviation for a sensor data type associated with the normalized sensor value 327AM. For example, each of the input sensor value 309 having the same position in a corresponding set of input time-series data 109 has the same sensor data type, and the batch normalization layer 220 determines a corresponding mean and a corresponding standard deviation. To illustrate, the batch normalization layer 220 determines a mean_{A} and standard deviation_{A} for the input sensor values (e.g., the input sensor value 309AA, the input sensor value 309AD, the input sensor value 309AJ, the input sensor value 309AM, one or more additional input sensor values, or a combination thereof) having the Ath position. Similarly, the batch normalization layer 220 determines a mean_{R} and standard deviation_{R} for the input sensor values (e.g., the input sensor value 309RA, the input sensor value 309RD, the input sensor value 309RJ, the input sensor value 309RM, one or more additional input sensor values, or a combination thereof) having the Rth position.

The batch normalization layer 220 generates a normalized sensor value 327AM by normalizing the input sensor value 309AM based on the mean_{A} and standard deviation_{A} (e.g., normalized sensor value 327AM=(input sensor value 309AM−mean_{A})/(standard deviation_{A})). Similarly, the batch normalization layer 220 generates a normalized sensor value 327RM by normalizing the input sensor value 309RM based on mean_{R} and standard deviation_{R} (e.g., normalized sensor value 327RM=(input sensor value 309RM−mean_{R})/(standard deviation_{R})).

The normalized sensor values 327 can be divided in various groups for analysis. For example, the groups of the normalized sensor values 327 correspond to the groups of the input sensor values 309. To illustrate, the normalized sensor values 327 are grouped into sets of normalized time-series data 229. Each of the sets of normalized time-series data 229 corresponds to a particular set of the input time-series data 109. For example, normalized time-series data 229A, normalized time-series data 229D, normalized time-series data 229J, and the normalized time-series data 229M correspond to the input time-series data 109A, the input time-series data 109D, the input time-series data 109J, and the input time-series data 109M, respectively.

As used herein, a pair of letters at the end of a reference number corresponding to a normalized sensor value indicates a corresponding position and an associated time range. The first letter of the pair indicates a position of the normalized sensor value within a set of normalized time-series data and the second letter of the pair indicates an associated time range. For example, “327AM” corresponds to a normalized sensor value that has an Ath position (e.g., indicated by the first letter “A”) among the normalized sensor values of the normalized time-series data 229M and that is associated with the Mth time range (e.g., indicated by the second letter “M”). As another example, “327RM” corresponds to a normalized sensor value that has an Rth position (e.g., indicated by the first letter “R”) among the normalized sensor values of the normalized time-series data 229M and that is associated with the Mth time range (e.g., indicated by the second letter “M”).

In a particular aspect, a position of the normalized sensor value corresponds to a position of a corresponding input sensor value. For example, the normalized sensor value 327RM is based on the input sensor value 309RM, and has the same position (e.g., Rth position) among the normalized sensor values of the normalized time-series data 229M that the input sensor value 309RM has among input sensor values of the input time-series data 109M. The batch normalization layer 220 enables the distribution of normalized input sensor values to remain the same for different batches, thereby improving prediction accuracy of the time-series data predictor 140.

Returning to FIG. 2, the embedding generator 108 is configured to process the normalized time-series data 229M using the spatial attention layer 230 to generate weighted time-series data 239M. For example, as illustrated in FIG. 4, the embedding generator 108 uses the spatial attention layer 230 to process the batch of normalized time-series data 221 to generate a batch of weighted time-series data 427.

In a particular aspect, each set of the normalized time-series data 229 associated with a particular time range is processed by the spatial attention layer 230 to generate a corresponding set of weighted time-series data 239. To illustrate, the spatial attention layer 230 applies spatial weights 432 to the normalized sensor values 327 of the normalized time-series data 229M to generate weighted sensor values 409 of the weighted time-series data 239M. For example, the spatial attention layer 230 applies a first weight of the spatial weights 432 to the normalized sensor value 327AM to generate a weighted sensor value 409AM. As another example, the spatial attention layer 230 applies a second weight of the spatial weights 432 to the normalized sensor value 327RM to generate a weighted sensor value 409RM. The second weight may be the same as or different from the first weight.

In a particular aspect, the spatial attention layer 230 accounts for spatial dependencies. “Spatial dependencies” as used herein refers to dependencies between the one or more sensors 104. For example, the spatial attention layer 230 generates the weighted sensor values 409 by applying a higher weight to normalized sensor values 327 of a first sensor that has a greater impact (e.g., greater importance) on predicted sensor values of the predicted time-series data 153. As an illustrative example, if proper operation of the system 180 is sensitive to temperature changes, the spatial attention layer 230 can apply a higher weight to a normalized sensor value 327 that is based on an input sensor value 309 generated by a temperature sensor. To illustrate, the spatial weights 432 include a first weight (e.g., 0.4) associated with a first sensor data type (e.g., temperature) and a second weight (e.g., 0.2) associated with a second sensor data type (e.g., pressure).

In some implementations, the spatial attention layer 230 determines that the normalized sensor value 327AM is of the first sensor data type (e.g., temperature) in response to determining that metadata of the input sensor value 309AM indicates that the input sensor value 309AM is of the first sensor data type and that the normalized sensor value 327AM is based on (e.g., is the normalized version of) the input sensor value 309AM. The spatial attention layer 230, in response to determining that the normalized sensor value 327AM is of the first data type, applies the first weight associated with the first sensor data type to the normalized sensor value 327AM to generate the weighted sensor value 409AM. Similarly, the spatial attention layer 230, in response to determining that the normalized sensor value 327RM is of the second sensor data type, applies the second weight associated with the second sensor data type to the normalized sensor value 327RM to generate the weighted sensor value 409RM.

In some implementations, the output generator 182 of FIG. 1 determines the feature importance data 157M based on the spatial weights 432 that are used by the spatial attention layer 230 to generate the weighted time-series data 239M. For example, the output generator 182 determines a first importance of the first sensor data type (e.g., a first feature) based on the first weight (e.g., 0.4) associated with the first sensor data type. As another example, the output generator 182 determines a second importance of the second sensor data type (e.g., a second feature) based on the second weight (e.g., 0.2) associated with the second sensor data type. For example, the first importance and the second importance indicate that the first sensor data type (e.g., temperature) is twice as important (e.g., has twice the impact) as the second sensory data type (e.g., pressure) in generating the weighted time-series data 239M. The weighted time-series data 239M is used to generate the input embedding 118M, as further described with reference to FIGS. 5-6B. The input embedding 118M is used to generate the predicted time-series data 153N, as further described with reference to FIGS. 7-8. The feature importance data 157M indicates that the first feature (e.g., temperature) has the first importance and that the second feature (e.g., pressure) has the second importance in generating the weighted time-series data 239M, the input embedding 118M, and the predicted time-series data 153N. The output generator 182 determines the output data 127 based on the predicted time-series data 153N and the feature importance data 157M, as described with reference to FIG. 1.

As used herein, a pair of letters at the end of a reference number corresponding to a weighted sensor value indicates a corresponding position and an associated time range. The first letter of the pair indicates a position of the weighted sensor value within a set of weighted time-series data and the second letter of the pair indicates an associated time range. For example, “409AM” corresponds to a weighted sensor value that has an Ath position (e.g., indicated by the first letter “A”) among the weighted sensor values of the weighted time-series data 239M and that is associated with the Mth time range (e.g., indicated by the second letter “M”). As another example, “409RM” corresponds to a weighted sensor value that has an Rth position (e.g., indicated by the first letter “R”) among the weighted sensor values of the weighted time-series data 239M and that is associated with the Mth time range (e.g., indicated by the second letter “M”).

In a particular aspect, a position of the weighted sensor value corresponds to a position of a corresponding input sensor value. For example, the weighted sensor value 409RM is based on the normalized sensor value 327RM and the normalized sensor value 327RM is based on the input sensor value 309RM. The weighted sensor value 409RM has the same position (e.g., Rth position) among the weighted sensor values of the weighted time-series data 239M that the input sensor value 309RM has among the input sensor values of the input time-series data 109M.

In some implementations, the spatial attention layer 230 processes each set of the normalized time-series data 229 sequentially to generate the corresponding set of the weighted time-series data 239. In other implementations, the one or more pre-processing layers 103 include multiple spatial attention layers 230 that can process multiple sets of the normalized time-series data 229 concurrently to generate the corresponding sets of the weighted time-series data 239.

Returning to FIG. 2, the embedding generator 108 is configured to process a sequence of weighted time-series data 231M using the convolution layer 240 to generate convolved time-series data 249M. For example, as illustrated in FIG. 5, the embedding generator 108 uses the convolution layer 240 to process the batch of weighted time-series data 427 to generate a batch of convolved time-series data 529.

The sets of weighted time-series data 239 are grouped into sequences of weighted time-series data 231. In an illustrative example, the weighted time-series data 239A, the weighted time-series data 239D, one or more additional sets of weighted time-series data, or a combination thereof, are grouped into a sequence of weighted time-series data 231D. As another example, the weighted time-series data 239J, the weighted time-series data 239M, one or more additional sets of weighted time-series data, or a combination thereof, are grouped into a sequence of weighted time-series data 231M.

A particular sequence of weighted time-series data 231 may overlap one or more other sequences of weighted time-series data 231. For example, a sequence of weighted time-series data 231D includes one or more of the sets of weighted time-series data 239 of the sequence of weighted time-series data 231D and one or more additional sets of weighted time-series data 239. In an illustrative implementation, the sequences may correspond to a window that includes multiple sets of the weighted time-series data 239 and that moves forward one set of weighted time-series data 239 of the batch of weighted time-series data 427 for each sequence. In this implementation, the sequence of weighted time-series data 231E excludes the weighted time-series data 239A, includes the remaining sets of weighted time-series data 239 of the sequence of weighted time-series data 231D, and includes weighted time-series data 239E.

A sequence of weighted time-series data 231 is processed by the convolution layer 240 to generate a corresponding set of convolved time-series data 249. For example, the embedding generator 108 processes the sequence of weighted time-series data 231D using the convolution layer 240 to generate convolved time-series data 249D. As another example, the embedding generator 108 processes the sequence of weighted time-series data 231E using the convolution layer 240 to generate convolved time-series data 249E. In a particular example, the embedding generator 108 processes the sequence of weighted time-series data 231M using the convolution layer 240 to generate convolved time-series data 249M.

As used herein, a letter at the end of a reference number corresponding to a sequence of weighted time-series data indicates a last one of a plurality of associated time ranges. For example, “231M” corresponds to a sequence of weighted time-series data that includes the weighted time-series data 239M associated with the Mth time range and one or more additional sets of weighted time-series data associated with one or more time ranges that are at least partially prior to the Mth time range. The sequence of weighted time-series data 231M associated with the Mth time range is processed by the convolution layer 240 to generate the convolved time-series data 249M associated with the Mth time range.

In some implementations, the convolution layer 240 processes each of the sequences of weighted time-series data 231 sequentially to generate a corresponding set of convolved time-series data 249. In other implementations, the one or more pre-processing layers 103 include multiple convolution layers 240 that can process multiple sequences of weighted time-series data 231 concurrently to generate the corresponding sets of the convolved time-series data 249.

In a particular aspect, the convolution layer 240 accounts for temporal dependencies between the time ranges associated with each set of the weighted time-series data 239 included in a sequence of weighted time-series data 231. In a particular aspect, the convolution layer 240 generates a set of the convolved time-series data 249 by applying convolution weights to a sequence of weighted time-series data 231. In some examples, the convolution layer 240 smoothens (e.g., de-jitters) the weighted sensor values 409 to generate convolved sensor values 527. For example, the convolution layer 240 generates a convolved sensor value 527AM based on a weighted sum of the weighted sensor value 409AJ, the weighted sensor value 409AM, and one or more additional weighted sensor values 409 corresponding to a first column of the sequence of weighted time-series data 231M. In a particular implementation, the convolved sensor value 527AM is based on an average of the weighted sensor value 409AJ, the weighted sensor value 409AM, and one or more additional weighted sensor values 409 corresponding to a first column of the sequence of weighted time-series data 231M. In another implementation, higher convolution weights are applied to more recent sensor values. For example, a higher convolution weight is applied to the weighted sensor value 409AM than the convolution weight applied to the weighted sensor value 409AJ in determining the weighted sum corresponding to the convolved sensor value 527AM.

As used herein, a pair of letters at the end of a reference number corresponding to a convolved sensor value indicates a corresponding position and an associated time range. The first letter of the pair indicates a position of the convolved sensor value within a set of convolved time-series data and the second letter of the pair indicates an associated time range. For example, “527AM” corresponds to a convolved sensor value that has an Ath position (e.g., indicated by the first letter “A”) among the convolved sensor values of the convolved time-series data 249M and that is associated with the Mth time range (e.g., indicated by the second letter “M”). As another example, “527RM” corresponds to a convolved sensor value that has an Rth position (e.g., indicated by the first letter “R”) among the convolved sensor values of the convolved time-series data 249M and that is associated with the Mth time range (e.g., indicated by the second letter “M”).

In a particular aspect, a position of the convolved sensor value corresponds to a position of one or more corresponding input sensor values. For example, the convolved sensor value 527RM is based on one or more of the weighted sensor values of the sequence of weighted time-series data 231M that have the Rth position. To illustrate, the convolved sensor value 527RM is based on the weighted sensor value 409RJ, the weighted sensor value RM, one or more additional weighted sensor values of the sequence of weighted time-series data 231M having the Rth position, or a combination thereof. The one or more weighted sensor values having the Rth position are based on one or more input sensor values having the Rth position. The convolved sensor value 527RM has the same position (e.g., the Rth position) among the convolved sensor values of the convolved time-series data 249 that the one or more input sensor values have among input sensor values of corresponding input time-series data.

FIGS. 6A and 6B illustrate examples of implementations of the embedding generator 108. In FIG. 6A, the embedding generator 108 generates an input embedding 118 including scalar values. In FIG. 6B, the embedding generator 108 generates an input embedding 118 including a positional embedding, one or more temporal embeddings, or a combination thereof, in addition to the scaler values.

Referring to FIG. 6A, a diagram 600 of an implementation of the embedding generator 108 is shown. The embedding generator 108 generates the input embedding 118M including scalar values 601 corresponding to the input time-series data 109M.

In a particular example, the embedding generator 108 processes the input time-series data 109M to generate the convolved time-series data 249M, as described with reference to FIGS. 2-5. The embedding generator 108 generates the input embedding 118M based on the convolved time-series data 249M. For example, the input embedding 118M includes the convolved time-series data 249M as the scalar values 601. To illustrate, the scalar values 601 include the convolved sensor value 527AM corresponding, the convolved sensor value 527RM, one or more additional convolved sensor values, or a combination thereof.

Referring to FIG. 6B, a diagram 650 of an implementation of the embedding generator 108 is shown. The embedding generator 108 generates the input embedding 118M including a positional embedding 603, a temporal embedding 605, a temporal embedding 607, a temporal embedding 609, one or more additional temporal embeddings, or a combination thereof, in addition to the scalar values 601.

In a particular aspect, the positional embedding 603 includes positional data 623 associated with each of the scalar values 601. For example, the positional embedding 603 includes positional data 623A associated with the convolved sensor value 527AM, positional data 623R associated with the convolved sensor value 527RM, one or more additional sets of positional data 623 associated with one or more additional convolved sensor values 527, or a combination thereof.

The positional data 623 indicates a position of a convolved sensor value 527 among one or more of the convolved sensor values of the convolved time-series data 249M. In some implementations, the position of the convolved sensor value 527, indicated by the positional data 623, corresponds to an overall position. For example, the position (e.g., Ath position) of the convolved sensor value 527AM, indicated by the positional data 623A, corresponds to the position (e.g., the Ath position) of the input sensor value 309AM among all sensor values of the input time-series data 109M. As another example, a position (e.g., Rth position) of the convolved sensor value 527RM, indicated by the positional data 623R, corresponds to the position (e.g., the Rth position) of the input sensor value 309RM among all sensor values of the input time-series data 109M.

In some implementations, the position of the convolved sensor value 527 indicated by the positional data 623 corresponds to a position of the corresponding input sensor values relative to other input sensor values generated by the same sensor 104 in the input time-series data 109.

In an illustrative example, the input time-series data 109J includes two input sensor values 309 from a first sensor 104 and one or more additional sensor values from a second sensor 104. As an example, the input sensor value 309RJ is the second sensor value received from or generated by the first sensor 104 and is the Rth sensor value among the input sensor values 309 of the input time-series data 109J. Similarly, the input time-series data 109M includes two input sensor values 309 from the first sensor 104 and one or more additional sensor values from the second sensor 104. As an example, the input sensor value 309RM is the second sensor value received from or generated by the first sensor 104 and is the Rth sensor value among the input sensor values 309 of the input time-series data 109M. The position of the convolved sensor value 527RM, indicated by the positional data 623R, includes the overall position (e.g., the Rth position) relative to all other input sensor values of the input time-series data 109M, the relative position (e.g., the 2nd position) associated with input sensor values of the first sensor 104 included in the input time-series data 109M, or both.

In a particular aspect, a temporal embedding 605 includes temporal data associated with each of the scalar values 601. For example, the temporal embedding 605 includes temporal data 625AM associated with the convolved sensor value 527AM, temporal data 625RM associated with the convolved sensor value 527RM, one or more additional sets of temporal data 625 associated with one or more additional convolved sensor values 527, or a combination thereof.

As used herein, a pair of letters at the end of a reference number associated with temporal data indicates a corresponding position and an associated time range. The first letter of the pair indicates a position of the temporal data within the temporal embedding 605 and the second letter of the pair indicates an associated time range. For example, “625AM” corresponds to temporal data that has an Ath position (e.g., indicated by the first letter “A”) among the temporal data of the temporal embedding 605 and that is associated with the Mth time range (e.g., indicated by the second letter “M”).

In a particular aspect, the temporal data 625AM is associated with the convolved sensor value 527AM. The position (e.g., Ath position) of the temporal data 625AM corresponds to the position (e.g., the Ath position) of the input sensor value 309AM among the input sensor values of the input time-series data 109M.

In a particular aspect, temporal data indicates that the input sensor value 309 associated with the convolved sensor value 527 is included in at least one of an hour, a day, a week, a month, or a holiday. In a particular aspect, the temporal data has an hour field (e.g., a bitmap) that can represent one of twenty-four values to indicate an hour of the day, a day field (e.g., a bitmap) that can represent one of seven values to indicate a day of the week, a week field (e.g., a bitmap) that can represent one of five values to indicate a week of the month, a month field (e.g., a bitmap) that can represent one of twelve values to indicate a month of the year, a holiday field (e.g., a bitmap) that can represent a value indicating one or more holidays, or a combination thereof.

Fields of the temporal data implemented as bitmaps is provided as an illustrative example. In some examples, one or more the fields may be implemented using various data types, such as a nibble (e.g., 4 bits), a byte (e.g., 8 bits), a halfword (e.g., 16 bits), a word (e.g., 32 bits), a doubleword (e.g., 64 bits), or another data type. To illustrate, the day of the week field can be represented using a bitmap including 7 bits with each bit corresponding to a particular day. For example, bit 1 corresponds to Monday, bit 2 corresponds to Tuesday, bit 3 corresponds to Wednesday, bit 4 corresponds to Thursday, bit 5 corresponds to Friday, bit 6 corresponds to Saturday, and bit 7 corresponds to Sunday. In another implementation, the day of the week field can be represented using 3 bits. For example, bit value 001 represents Monday, bit value 010 represents Tuesday, bit value 011 represents Wednesday, bit value 100 represents Thursday, bit value 101 represents Friday, bit value 110 represents Saturday, and bit value 111 represents Sunday.

As an example, the convolved sensor value 527AM is based on the input sensor value 309AM of the input time-series data 109M associated with the Mth time range (e.g., 12:00 PM-12:30 PM on Jan. 1, 2021). The input sensor value 309AM is associated with (e.g., has a receipt timestamp or a generation timestamp indicating) a first time (e.g., 12:05 PM on Jan. 1, 2021).

In a particular aspect, the temporal data 625AM associated with the convolved sensor value 527AM has an hour field, a day field, a week field, and a month field with a first value indicating an hour of the day (e.g., 13th hour), a second value indicating a day of the week (e.g., 5th day), a third value indicating a week of the month (e.g., 1st week), and a fourth value indicating a month of the year (e.g., 1st month), respectively, corresponding to the first time (e.g., 12:05 PM on Jan. 1, 2021). In a particular aspect, the temporal data 625AM has a holiday field (e.g., a bitmap) with a value indicating a particular holiday (e.g., New Year Day) corresponding to the first time (e.g., 12:05 PM on Jan. 1, 2021).

In some implementations, the holiday field includes a bitmap with each bit associated with a particular holiday. For example, a first bit of holiday field is associated with a weekend and a second bit of the holiday field is associated with New Year Day. A first value (e.g., 0) of the first bit indicates that the first time (e.g., 12:05 PM on Jan. 1, 2021) is not included in a weekend. A second value (e.g., 1) of the second bit indicates that the first time (e.g., 12:05 PM on Jan. 1, 2021) occurred on New Year Day. In some aspects, multiple bits of the holiday field can have the second value (e.g., 1) to indicate that the first time is associated with multiple holidays.

In some implementations, the embedding generator 108 is configured to generate hierarchical temporal embeddings. For example, the embedding generator 108 generates the temporal embedding 605 and a temporal embedding 607. The temporal embedding 607 includes temporal data 627AM associated with the convolved sensor value 527AM, temporal data 627RM associated with the convolved sensor value 527RM, one or more additional sets of temporal data 627 associated with one or more additional convolved sensor values 527, or a combination thereof. As an illustrative non-limiting example, the temporal data 625 includes the day field with a value indicating that the first time (e.g., 12:05 PM on Jan. 1, 2021) is included in the 5th day of the week, and the temporal data 627 includes the week field with a value indicating that the first time is included in the first week of the month.

In some implementations, the embedding generator 108 generates a temporal embedding 609 that is independent of the temporal hierarchy. For example, the temporal embedding 609 includes temporal data 629AM associated with the convolved sensor value 527AM, temporal data 629RM associated with the convolved sensor value 527RM, one or more additional sets of temporal data 629 associated with one or more additional convolved sensor values 527, or a combination thereof. As an illustrative non-limiting example, the temporal data 629AM includes the holiday field with a value indicating that the first time (e.g., 12:05 PM on Jan. 1, 2021) is included in New Year Day.

The input embedding 118M is processed by the predictor 114 to generate the predicted time-series data 153N, as further described with reference to FIGS. 7-8. Including the positional embedding 603 in the input embedding 118M enables the predictor 114 to account for positional dependencies across the input sensor values 309 of the input time-series data 109M to improve prediction accuracy. Including the one or more temporal embeddings 605 enables the predictor 114 to account for temporal dependencies associated with different time frames (e.g., particular hours, days, weeks, months, etc.) or different holidays to improve prediction accuracy. For example, the system 180 may operate or be used differently on a weekend than on a weekday. An indication of whether the scalar values 602 correspond to input time-series data from a weekend or a weekday can help distinguish anomalies or operational modes.

Referring to FIG. 7, a diagram of an implementation of the time-series data predictor 140 is shown and generally designated 700. The time-series data predictor 140 includes the embedding generator 108 coupled to the predictor 114. The predictor 114 includes an encoder 710 coupled to a decoder 712.

In some implementations, the embedding generator 108 is external to the encoder 110, the predictor 114, or both. In other implementations, the encoder 110, the predictor 114, or both, include the embedding generator 108. In some examples, the embedding generator 108 can provide at least a portion of the input embedding 118M to the decoder 712, as further described with reference to FIG. 8.

The encoder 710 includes one or more encoding layers 750. The embedding generator 108 is coupled to the one or more encoding layers 750. The one or more encoding layers 750 are configured to process the input embedding 118M to generate encoded data 751M. In some aspects, at least one of the one or more encoding layers 750 includes a masked attention layer and a feed forward layer. The masked attention layer includes a masked attention network, such as a masked multi-head attention network 754. In a particular aspect, an input to the masked multi-head attention network 754 is based on the input embedding 118M, and the encoded data 751M is based on an output of the masked multi-head attention network 754. The feed forward layer includes a feed forward neural network, such as a feed forward 758 (e.g., a fully connected feed forward neural network). In some examples, the masked attention layer includes a normalization layer, such as a layer norm 752, coupled to the masked multi-head attention network 754. In some examples, the feed forward layer includes a normalization layer, such as a layer norm 756, coupled to the feed forward 758. The masked attention layer is coupled to the feed forward layer. For example, the masked multi-head attention network 754 is coupled to the layer norm 756.

The one or more encoding layers 750 including a single encoding layer is provided as an illustrative example. In other examples, the one or more encoding layers 750 include multiple encoding layers with an output of the embedding generator 108 of FIG. 1 coupled to the masked attention layer (e.g., the layer norm 752) of an initial encoding layer, the feed forward layer (e.g., the feed forward 758) of each previous encoding layer coupled to the masked attention layer (e.g., the layer norm 752) of a subsequent encoding layer, and the feed forward layer (e.g., the feed forward 758) of a last encoding layer coupled to an output of the encoder 710.

The decoder 712 includes one or more decoding layers 760. The one or more decoding layers 760 are configured to process the encoded data 751M to generate the predicted time-series data 153N associated with the Nth time range. In some aspects, at least one of the one or more decoding layers 760 includes a masked attention layer and a feed forward layer. The masked attention layer includes a masked attention network, such as a masked multi-head attention network 764. In a particular aspect, an input to the masked multi-head attention network 764 is based on the encoded data 751M, and the predicted time-series data 153N is based on an output of the masked multi-head attention network 764.

The feed forward layer includes a feed forward neural network, such as a feed forward 768 (e.g., a fully connected feed forward neural network). In some examples, the masked attention layer includes a normalization layer, such as a layer norm 762, coupled to the masked multi-head attention network 764. In some examples, the feed forward layer includes a normalization layer, such as a layer norm 766, coupled to the feed forward 768. The masked attention layer is coupled to the feed forward layer. For example, the masked multi-head attention network 764 is coupled to the layer norm 766.

The one or more decoding layers 760 including a single decoding layer is provided as an illustrative example. In other examples, the one or more decoding layers 760 include multiple decoding layers with an output of the encoder 710 coupled to the masked attention layer (e.g., the layer norm 762) of an initial decoding layer, the feed forward layer (e.g., the feed forward 768) of each previous decoding layer coupled to the masked attention layer (e.g., the layer norm 762) of a subsequent decoding layer, and the feed forward layer (e.g., the feed forward 768) of a last decoding layer coupled to an output of the decoder 712. In some implementations, the predictor 114 may include one or more additional layers, one or more additional connections, or a combination thereof, that are not shown for ease of illustration.

The embedding generator 108 is configured to process the input time-series data 109M to generate the input embedding 118M. The encoder 710 is configured to process the input embedding 118M associated with the Mth time range (e.g., 12:00 PM-12:30 PM on Jan. 1, 2021) to generate the encoded data 751M. For example, an input to the masked multi-head attention network 754 is based on the input embedding 118M. In a particular aspect, the input embedding 118M is provided, subsequent to normalization by the layer norm 752, as the input to the masked multi-head attention network 754.

In a particular aspect, the masked multi-head attention network 754 masks future positions in the input to the masked multi-head attention network 754. In some implementations, the masked multi-head attention network 754 can build a context vector from different aspects using different attention heads. For example, the masked multi-head attention network 754 includes multiple attention heads that process the masked version of the input to the masked multi-head attention network 754 in parallel. To illustrate, the masked input is multiplied by a first matrix, a second matrix, and a third matrix to generate a first Query vector, a first Key vector, and a first Value vector, respectively. The first Query vector, the first Key vector, and the first Value vector are processed by a first attention head. The masked input is multiplied by a fourth matrix, a fifth matrix, and a sixth matrix to generate a second Query vector, a second Key vector, and a second Value vector, respectively. The second Query vector, the second Key vector, and the second Value vector are processed by a second attention head in parallel or concurrently with the first attention head processing the first Query vector, the first Key vector, and the first Value vector.

In a particular aspect, an output of an attention head corresponds to the following Equation:

$$Z = softmax ( \frac{{QxK}^{T}}{\sqrt{{d}_{k}}} ) V ,$$

where Z corresponds to an output of the attention head, Q corresponds to the Query vector, x corresponds to the multiplication operator, K^{T} corresponds to a transpose of the Key vector, V corresponds to the Value vector, dₖ corresponds to the dimension of the Key vectors, and softmax corresponds to a normalization operation.

The independent outputs of the attention heads are concatenated and linearly transformed to generate an output of the masked multi-head attention network 754. The encoded data 751M is based on the output of the masked multi-head attention network 754. In some aspects, the output of the masked multi-head attention network 754 is provided, subsequent to normalization by the layer norm 756, to the feed forward 758 (e.g., a fully connected feed forward neural network). In a particular example, the feed forward 758 includes a first linear transformation layer coupled via a rectified linear unit (ReLU) layer to a second linear transformation layer. The output of the feed forward 758 corresponds to the encoded data 751M. The encoder 710 provides the encoded data 751M to the decoder 712.

The decoder 712 is configured to process the encoded data 751M to generate the predicted time-series data 153N. For example, an input to the masked multi-head attention network 764 is based on the encoded data 751M. In a particular aspect, the encoded data 751M is provided, subsequent to normalization by the layer norm 762, as the input to the masked multi-head attention network 764.

In a particular aspect, the masked multi-head attention network 764 masks future positions in the input to the masked multi-head attention network 764. In some implementations, the masked multi-head attention network 764 can build a context vector from different aspects using different attention heads. For example, the masked multi-head attention network 764 includes multiple attention heads that process the masked version of the input to the masked multi-head attention network 764 in parallel. To illustrate, the masked multi-head attention network 764 generates Query vectors, Key vectors, and Value vectors by multiplying the masked input version of the input with matrices. Each of multiple attention heads processes a set of Query vector, Key vector, and Value vector in parallel or concurrently with another attention head processing another set of Query vector, Key vector, and Value vector. The independent outputs of the attention heads are concatenated and linearly transformed to generate an output of the masked multi-head attention network 764.

The predicted time-series data 153N is based on an output of the masked multi-head attention network 764. In some aspects, the output of the masked multi-head attention network 764 is provided, subsequent to normalization by the layer norm 766, to the feed forward 768 (e.g., a fully connected feed forward neural network). In a particular example, the feed forward 768 includes a first linear transformation layer coupled via a ReLU layer to a second linear transformation layer. The output of the feed forward 768 corresponds to the predicted time-series data 153N.

The predicted time-series data 153N is associated with an Nth time range that is at least partially subsequent to the Mth time range. For example, a second start time of the Nth time range is greater than the first start time (e.g., 12:00 PM on Jan. 1, 2021) of the Mth time range (e.g., 12:00 PM-12:30 PM on Jan. 1, 2021). In some implementations, the Nth time range (e.g., 12:10 PM-12:40 PM on Jan. 1, 2021) overlaps the Mth time range. For example, the second start time (e.g., 12:10 PM on Jan. 1, 2021) is less than the first end time (e.g., 12:30 PM on Jan. 1, 2021) of the Mth time range (e.g., 12:00 PM-12:30 PM on Jan. 1, 2021). In other implementations, the Nth time range (e.g., 12:30 PM-1:00 PM on Jan. 1, 2021) does not overlap the Mth time range. For example, the second start time (e.g., 12:30 PM on Jan. 1, 2021) is greater than or equal to the first end time (e.g., 12:30 PM on Jan. 1, 2021) of the Mth time range (e.g., 12:00 PM-12:30 PM on Jan. 1, 2021).

Referring to FIG. 8, a diagram of an implementation of the time-series data predictor 140 is shown and generally designated 800. The time-series data predictor 140 includes an embedding generator 860 coupled to the decoder 712.

The decoder 712 includes an attention layer in addition to a masked attention layer and a feed forward layer. The attention layer includes a multi-head attention network 864. For example, the masked multi-head attention network 764 is coupled via the layer norm 766 to the multi-head attention network 864.

In some implementations, the multi-head attention network 864 includes multiple attention heads and an output of the masked multi-head attention network 764, subsequent to normalization by the layer norm 766, is provided to each of the attention heads of the multi-head attention network 864. The encoded data 751M is provided to the multi-head attention network 864. In some aspects, the multi-head attention network 864 generates Query vectors based on the output of the masked multi-head attention network 764 and generates Key vectors and Value vectors based on the encoded data 751M. Each attention head of the multi-head attention network 864 processes a Query vector, a Key vector, and a Value vector to generate an output. Outputs of each of the attention heads of the multi-head attention network 864 are concatenated and linearly transformed to generate an output of the multi-head attention network 864.

The embedding generator 108 is configured to provide the input embedding 118M to the encoder 710 and the scalar values 601M to the embedding generator 860. The embedding generator 108 external to the predictor 114 is provided as an illustrative example. In some examples, the predictor 114 can include the embedding generator 108. For example, the encoder 710 can include the embedding generator 108. Similarly, the embedding generator 860 external to the predictor 114 is provided as an illustrative example. In some examples, the predictor 114 can include the embedding generator 860. For example, the decoder 712 can include the embedding generator 860.

The embedding generator 860 is configured to generate an embedding 801 based on the scalar values 601M. For example, the embedding 801 includes the scalar values 601M and one or more placeholder values 827. A count of the one or more placeholder values 827 corresponds to a count of predicted sensor values to be generated by the predictor 114. In some aspects, each of the one or more placeholder values 827 indicates a predetermined value (e.g., 0).

In some implementations, a count of the one or more placeholder values 827 corresponds to a count of predicted sensor values associated with time-series data of a single time range. In these implementations, an output of the decoder 712 corresponds to the predicted time-series data 153N associated with the Nth time range.

In some implementations, a count of the one or more placeholder values 827 corresponds to a count of predicted sensor values associated with time-series data of multiple time ranges. In these implementations, an output of the decoder 712 corresponds to the predicted time-series data 153N associated with the Nth time range, predicted time-series data 153Y associated with a Yth time range, one or more additional sets of predicted time-series data associated with remaining time ranges of the multiple time ranges, or a combination thereof. The embedding 801 thus enables one-shot decoding to generate predicted time-series data corresponding to multiple time ranges based on scalar values 601 associated with a single time range (e.g., the first time range). The multiple time ranges are at least partially subsequent to the Mth time range associated with the input embedding 118M.

The diagrams 700-800 provide illustrative examples of implementations of the predictor 114. In other examples, the predictor 114 can include various implementations. In some examples, at least one of the one or more encoding layers 750 can include a multi-head attention network (e.g., not masked) instead of the masked multi-head attention network 754.

In some examples, at least one of the one or more encoding layers 750 can include a first fourier transform network instead of the masked multi-head attention network 754. An input to the first fourier transform network is based on the input embedding 118M, and the encoded data 751M is based on an output of the first fourier transform network.

In a particular aspect, the first fourier transform network applies fourier weights to values (e.g., the input to the first fourier transform network) indicated by the input embedding 118M to generate an output. For example, the first fourier transform network corresponds to a fourier transform (e.g., a discrete fourier transform (DFT)) applied to the input embedding 118M. In some aspects, the output of the first fourier transform network is provided, subsequent to normalization by the layer norm 756, to the feed forward 758 (e.g., a fully connected feed forward neural network).

In some examples, at least one of the one or more decoding layers 760 can include a second fourier transform network instead of the masked multi-head attention network 764, a single-head attention network instead of the multi-head attention network 864, or both. An input to the second fourier transform network is based on the embedding 801, and the predicted time-series data 153 is based on an output of the second fourier transform network.

In a particular aspect, the second fourier transform network applies fourier weights to values (e.g., the input to the fourier transform network) indicated by the embedding 801 to generate an output. For example, the second fourier transform network corresponds to a fourier transform (e.g., a DFT) applied to the embedding 801. In some aspects, the output of the second fourier transform network is provided, subsequent to normalization by the layer norm 766, to the single-head attention network.

Referring to FIG. 9, a system operable to detect a mode change using the time-series data predictor 140 is shown and generally designated 900. In a particular aspect, the system 100 of FIG. 1 may include one or more components of the system 900.

The system 900 includes a residual generator 970 coupled, via a risk scorer 980, to a mode change detector 990. The residual generator 970 generates residual data 971N based on a comparison of the predicted time-series data 153N (e.g., predicted sensor values associated with the Nth time range) and the input time-series data 109N (e.g., actual sensor values associated with the Nth time range). In some implementations, the residual data 971N corresponds to a difference between the predicted time-series data 153N and the input time-series data 109N. In an illustrative example, the predicted time-series data 153N includes a predicted sensor value 909AN, a predicted sensor value 909RN, one or more additional predicted sensor values, or a combination thereof. The residual generator 970 determines a residual sensor value 919AN based on a difference between the predicted sensor value 909AN and a sensor value 309AN of the input time-series data 109N. As another example, the residual generator 970 determines a residual sensor value 919RN based on a difference between the predicted sensor value 909RN and a sensor value 309RN of the input time-series data 109N. The residual data 971N includes the residual sensor value 919AN, the residual sensor value 919RN, one or more additional residual sensor values, or a combination thereof. The residual generator 970 provides the residual data 971N to the risk scorer 980.

The risk scorer 980 generates a risk score 981N based on the residual data 971N and reference residual data 982. For example, the risk scorer 980 implements a Hotelling T² (or “T-squared”) test statistics that computes the risk score 981N:

$${t}^{2} = \frac{{n}_{x} {n}_{y}}{{n}_{x} + {n}_{y}} {( \overline{x} - \overline{y} )}^{′} {\hat{\sum }}^{- 1} ( \overline{x} - \overline{y} ) \sim {T}^{2} ( p , {n}_{x} + {n}_{y} - 2 ) ,$$

where x̅ and y̅ are the sample means of samples drawn from two multivariate distributions (e.g., the residual data 971N and the reference residual data 982) given as

$$\overline{x} = \frac{1}{{n}_{x}} {\sum }_{i = 1}^{{n}_{x}} {x}_{i} and \overline{y} = \frac{1}{{n}_{y}} {\sum }_{i = 1}^{{n}_{y}} {y}_{i} ,$$

with respective sample covariance matrices of

$${\hat{\sum }}_{x} = \frac{1}{{n}_{x} - 1} {\sum }_{i = 1}^{{n}_{x}} ( {x}_{i} - \overline{x} ) {( {x}_{i} - \overline{x} )}^{′} and$$

$${\hat{\sum }}_{y} = \frac{1}{{n}_{y} - 1} {\sum }_{i = 1}^{{n}_{y}} ( {y}_{i} - \overline{y} ) {( {y}_{i} - \overline{y} )}^{′} ,$$

(where an apostrophe (′) denotes transpose), where

$$\hat{\sum } = \frac{( {n}_{x} - 1 ) {\hat{\sum }}_{x} + ( {n}_{y} - 1 ) {\hat{\sum }}_{y}}{( {n}_{x} + {n}_{y} - 2 )}$$

is the unbiased pooled covariance matrix estimate, and where T² (p, m) is Hotelling's T-squared distribution with dimensionality parameter p and m degrees of freedom. Larger T² values indicate greater deviation from the expected values and therefore greater likelihood that there is a statistical difference between the residual data 971N and the normal operation indicated in the reference residual data 982.

The risk scorer 980 provides the risk score 981N to the mode change detector 990. The mode change detector 990 determines, based on the risk score 981N, whether a change in operating mode of the system 180 is detected. For example, the mode change detector 990 compares the risk score 981N to a mode change threshold and, in response to determining that the risk score 981N is greater than the mode change threshold, outputs the mode change indicator 991 having a first value (e.g., 1) indicating that a change in operating mode of the system 180 is detected. Alternatively, the mode change detector 990, in response to determining that the risk score 981N is less than or equal to the mode change threshold, outputs the mode change indicator 991 having a second value (e.g., 0) indicating that no change in operating mode of the system 180 is detected.

In a particular aspect, the mode change detector 990, determines based on the risk score 981N, whether a change in operating mode corresponds to an anomaly (e.g., predicts a future anomalous operating state of the system 180). In some implementations, any change in operating mode corresponds to an anomaly, and the anomaly indicator 993 is the same as the mode change indicator 991. In other implementations, the mode change detector 990 determines that the change in operating mode corresponds to an anomaly in response to determining that the risk score 981N is greater than an anomaly threshold. For example, the mode change detector 990, in response to determining that the risk score 981N is greater than the anomaly threshold, outputs the anomaly indicator 993 having a first value (e.g., 1) indicating that an anomaly is detected. Alternatively, the mode change detector 990, in response to determining that the risk score 981N is less than or equal to the anomaly threshold, outputs the anomaly indicator 993 having a second value (e.g., 0) indicating that no anomaly is detected. In some aspects, the anomaly threshold is greater than the mode change threshold.

In some implementations, the mode change detector 990 performs a sequential probability ratio test (SPRT) to selectively generate the mode change indicator 991, the anomaly indicator 993, or both, based on statistical data corresponding to a set of risk scores (e.g., a sequence or stream of risk scores 981) that includes the risk score 981N, and further based on reference risk scores 992. For example, the SPRT is a sequential hypothesis test that provides continuous validations or refutations of the hypothesis that the system 180 behaves abnormally, by determining whether the risk score 981N (e.g., the T² score) continues to follow, or no longer follows, the normal behavior statistics of the reference risk scores 992. In some implementations, the reference risk scores 992 include data indicative of a distribution of reference risk scores (e.g., mean and variance) instead of, or in addition to, the actual values of the reference risk scores. The SPRT provides an early detection mechanism and supports tolerance specifications for false positives and false negatives.

The mode change detector 990 provides the mode change indicator 991, the anomaly indicator 993, or both, to the output generator 182. The output generator 182 generates the output data 127 based at least in part on the mode change indicator 991, the anomaly indicator 993, or both. For example, the output data 127 includes a representation of the mode change indicator 991 indicating whether a change in operating mode of the system 180 is detected. As another example, the output data 127 includes a representation of the anomaly indicator 993 indicating whether an anomaly is detected.

In some aspects, the output generator 182 generates the output data 127 based on the feature importance data 157M. For example, the output data 127 indicates the relative importance of features of the input time-series data 109M in determining whether a change in operating mode is detected, whether an anomaly is detected, or both. In a particular implementation, the output generator 182 generates the output data 127 selectively based on the feature importance data 157M. For example, the output generator 182, in response to determining that the mode indicator 991 has a first value (e.g., 1) indicating that a change in operating mode is detected, generates the output data 127 based on the feature importance data 157M to indicate relative importance of features of the input time-series data 109M. In some examples, the output generator 182, in response to determining that the anomaly indicator 993 has a first value (e.g., 1) indicating that an anomaly is detected, generates the output data 127 to include an alert and to indicate relative importance of features of the input time-series data 109M. In a particular aspect, the output generator 182 provides the output data 127 to the device 106.

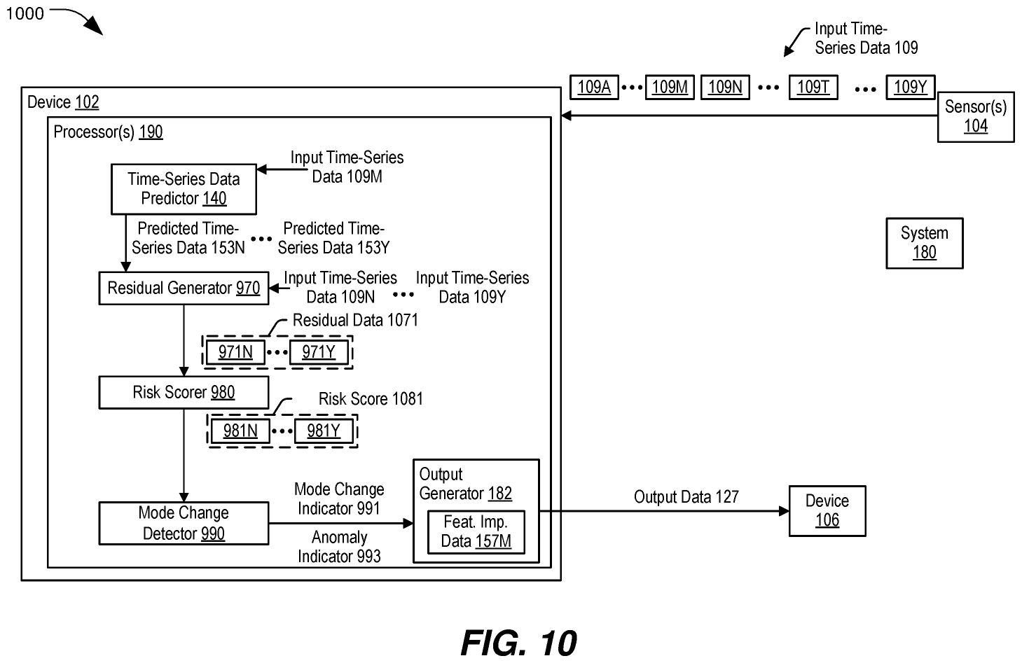

Referring to FIG. 10, a system operable to detect a mode change using the time-series data predictor 140 is shown and generally designated 1000. In a particular aspect, the system 100 may include one or more components of the system 1000.

The residual generator 970 generates residual data 1071 corresponding to multiple time ranges. For example, the residual data 1071 is based on a comparison of multiple sets of predicted time-series data 153 with corresponding multiple sets of input time-series data 109. To illustrate, the residual generator 970 generates the residual data 1071 including the residual data 971N that is based on a comparison of (e.g., difference between) the predicted time-series data 153N and the input time-series data 109N. As another example, the residual data 1071 includes residual data 971Y that is based on a comparison of (e.g., difference between) the predicted time-series data 153Y and the input time-series data 109Y.

The risk scorer 980 generates a risk score 1081 based on the residual data 1071. In some implementations, the risk score 1081 includes multiple risk scores corresponding to the multiple time ranges. For example, the risk score 1081 includes the risk score 981N that is based on the residual data 971N. As another example, the risk score 1081 includes a risk score 981Y that is based on the residual data 971Y.

The mode change detector 990 generates, based on the risk score 1081, the mode change indicator 991 indicating whether a change in operating mode of the system 180 is detected, the anomaly indicator 993 indicating whether an anomaly is detected, or both. The mode change detector 990 provides the mode change indicator 991, the anomaly indicator 993, or both, to the output generator 182. The output generator 182 generates the output data 127 based on the feature importance data 157M, the mode change indicator 991, the anomaly indicator 993, or a combination thereof.

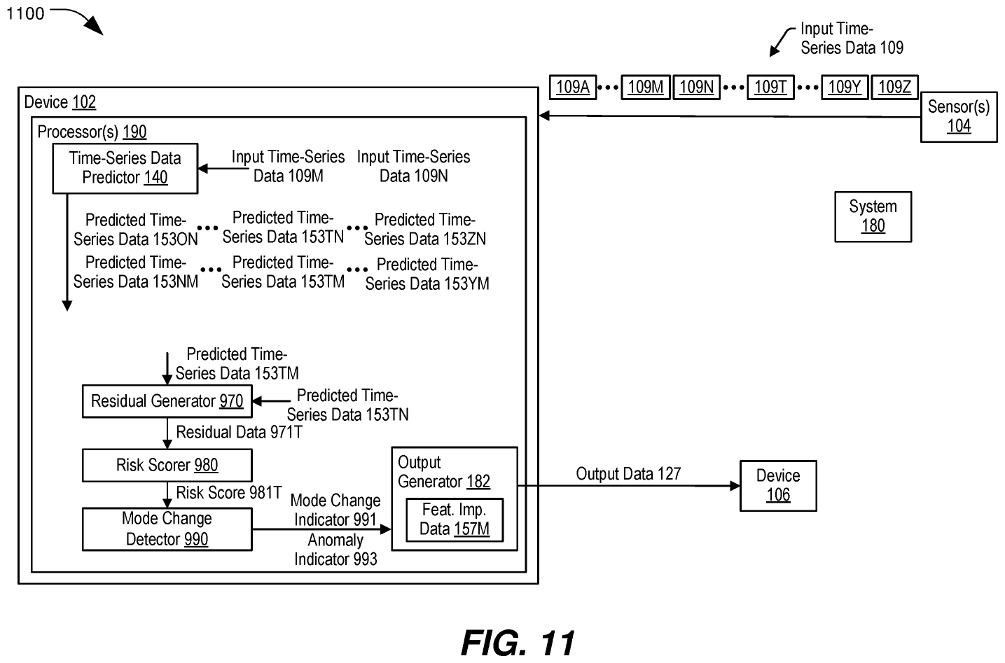

Referring to FIG. 11, a system operable to detect a mode change using the time-series data predictor 140 is shown and generally designated 1100. In a particular aspect, the system 100 may include one or more components of the system 1100.

In some implementations, the time-series data predictor 140 generates multiple sets of predicted time-series data associated with the same time range. For example, the time-series data predictor 140 processes the input time-series data 109M to generate multiple sets of predicted time-series data associated with multiple time ranges, as described with reference to FIG. 8. The multiple sets of predicted time-series data include predicted time-series data 153NM, predicted time-series data 153TM, predicted time-series data 153YM, one or more additional sets of predicted time-series data, or a combination thereof.

The time-series data predictor 140 receives the input time-series data 109N. The time-series data predictor 140 processes the input time-series data 109N to generate multiple sets of predicted time-series data associated with multiple time ranges, as described with reference to FIG. 8. The multiple sets of predicted time-series data include predicted time-series data 1530N, predicted time-series data 153TN, predicted time-series data 153ZN, one or more additional sets of predicted time-series data, or a combination thereof.

The residual generator 970 generates residual data 971T based on a comparison of (e.g., a difference between) the predicted time-series data 153TM and the predicted time-series data 153TN. The risk scorer 980 generates a risk score 981T based on the residual data 971T. The mode change detector 990 generates the mode change indicator 991, the anomaly indicator 993, or both, based on the risk score 981T. The mode change detector 990 provides the mode change indicator 991, the anomaly indicator 993, or both, to the output generator 182. The output generator 182 generates the output data 127 based on the feature importance data 157M, the mode change indicator 991, the anomaly indicator 993, or a combination thereof.

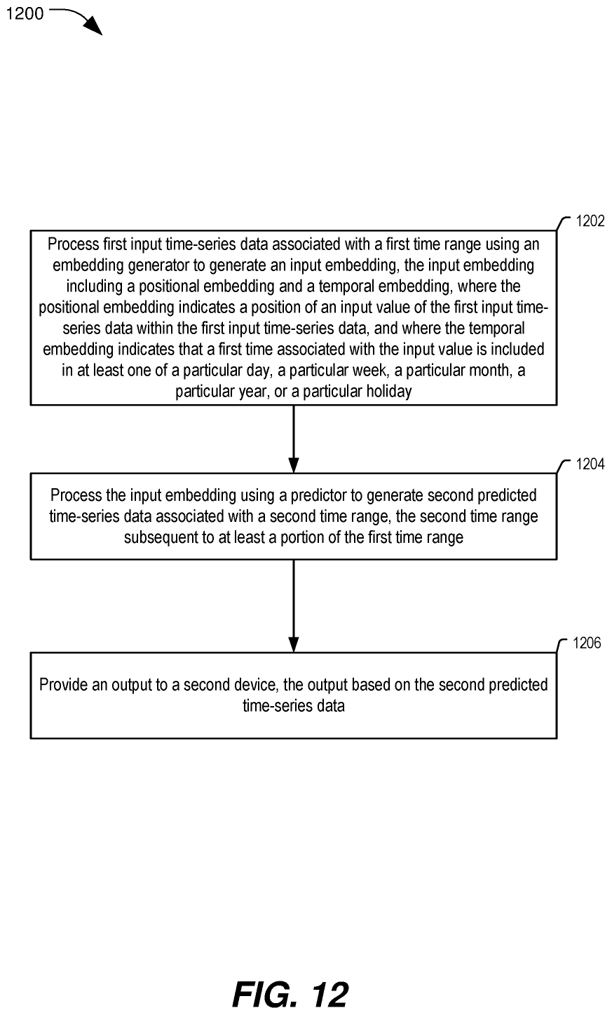

Referring to FIG. 12, a method of using a neural network embedding including a positional embedding and a temporal embedding for time-series data prediction is shown and generally designated 1200. In a particular aspect, one or more operations of the method 1200 are performed by the one or more pre-processing layers 103, the embedding generator 108, the one or more encoding layers 750, the encoder 710, the one or more decoding layers 760, the decoder 712, the predictor 114, the time-series data predictor 140, the one or more processors 190, the device 102, the system 100, or a combination thereof.

The method 1200 includes processing first input time-series data associated with a first time range using an embedding generator to generate an input embedding, at 1202. For example, the time-series data predictor 140 processes the input time-series data 109M associated with an Mth time range using the embedding generator 108 to generate the input embedding 118M, as described with reference to FIG. 1. The input embedding 118M includes the positional embedding 603, and at least one of the temporal embedding 605, the temporal embedding 607, or the temporal embedding 609, as described with reference to FIG. 6B. The positional embedding 603 indicates a position of the input sensor value 309AM of the input time-series data 109M within the input time-series data 109M. The temporal embedding 605, the temporal embedding 607, or both, indicate that a first time associated with the input sensor value 309AM is included in at least one of a particular day, a particular week, a particular month, or a particular year. The temporal embedding 609 indicates that the first time associated with the input sensor value 309AM is included in a particular holiday, as described with reference to FIG. 6B.

The method 1200 also includes processing the input embedding using a predictor to generate second predicted time-series data associated with a second time range, at 1204. For example, the time-series data predictor 140 processes the input embedding 118M using the predictor 114 to generate the predicted time-series data 153N associated with an Nth time range, as described with reference to FIG. 1. The Nth time range is subsequent to the Mth time range.

The method 1200 further includes providing an output to a second device, at 1206. For example, the time-series data predictor 140 provides the output data 127 to the device 106. The output data 127 is based on the predicted time-series data 153N.

If the predicted time-series data 153N corresponds to an anomalous operating state, measures can be taken to reduce the impact of the anomalous operating state or to prevent the anomalous operating state from occurring.

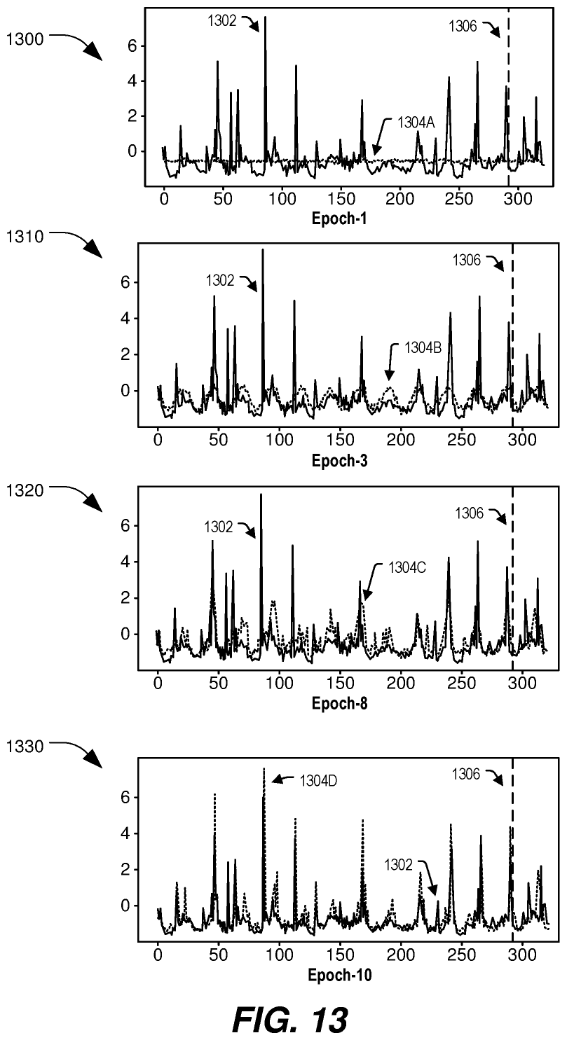

Referring to FIG. 13, comparison of input time-series data and predicted time-series data as the time-series data predictor 140 is trained over time (e.g., through multiple epochs, such as an Epoch 1, Epoch 3, Epoch 8, and Epoch 10 of an iterative training process) is shown. In a particular aspect, training of the time-series data predictor 140 includes updating one or more configuration settings of the embedding generator 108, the predictor 114, or both based on a comparison of the input time-series data 109 and the predicted time-series data 153.

In an example 1300, a line 1302 corresponds to the input time-series data 109, a line 1304A corresponds to the predicted time-series data 153 generated at a first time (e.g., corresponding to Epoch 1), and a line 1306 corresponds to an anomaly. The time-series data predictor 140 trains the embedding generator 108, the predictor 114, or both based on a comparison of at least a first subset of the input time-series data 109 and the predicted time-series data 153 generated at the first time. For example, the time-series data predictor 140 updates one or more configuration settings of the embedding generator 108, the predictor 114, or both. In an illustrative, non-limiting example, the one or more configuration settings include a spatial weight, a count of nodes, a count of layers, a neural network weight, a neural network bias, or a combination thereof.

In an example 1310, the line 1302 corresponds to the input time-series data 109, a line 1304B corresponds to the predicted time-series data 153 generated at a second time (e.g., corresponding to Epoch 3) that is subsequent to the first time, and the line 1306 corresponds to the anomaly. The embedding generator 108, the predictor 114, or both are trained based on the data corresponding to the first time prior to generating the predicted time-series data 153 at the second time. The predicted time-series data 153 generated at the second time is a closer approximation (as compared to the predicted time-series data 153 generated at the first time) of the input time-series data 109. The time-series data predictor 140 trains the embedding generator 108, the predictor 114, or both based on a comparison of at least a second subset of the input time-series data 109 and the predicted time-series data 153 generated at the second time. In a particular aspect, the first subset of the input time-series data 109 corresponds to a first time range that is earlier at least in part to a second time range associated with the second subset of the input time-series data 109.

In an example 1320, the line 1302 corresponds to the input time-series data 109, a line 1304C corresponds to the predicted time-series data 153 generated at third time (e.g., corresponding to Epoch 8) that is subsequent to the second time, and the line 1306 corresponds to the anomaly. The embedding generator 108, the predictor 114, or both are trained based on the data corresponding to the second time prior to generating the predicted time-series data 153 at the third time. The predicted time-series data 153 generated at the third time is a closer approximation (as compared to the predicted time-series data 153 generated at the second time) of the input time-series data 109. The time-series data predictor 140 trains the embedding generator 108, the predictor 114, or both based on a comparison of at least a third subset of the input time-series data 109 and the predicted time-series data 153 generated at the third time. In a particular aspect, the second time range associated with the second subset of the input time-series data 109 is earlier at least in part to a third time range associated with the third subset of the input time-series data 109.

In an example 1330, the line 1302 corresponds to the input time-series data 109, a line 1304D corresponds to the predicted time-series data 153 generated at a fourth time (e.g., corresponding to Epoch 10) that is subsequent to the third time, and the line 1306 corresponds to the anomaly. The embedding generator 108, the predictor 114, or both are trained based on the data corresponding to the third time prior to generating the predicted time-series data 153 at the fourth time. The predicted time-series data 153 generated at the fourth time is a closer approximation (as compared to the predicted time-series data 153 generated at the third time) of the input time-series data 109. The time-series data predictor 140 trains the embedding generator 108, the predictor 114, or both based on a comparison of at least a fourth subset of the input time-series data 109 and the predicted time-series data 153 generated at the fourth time. In a particular aspect, the third time range associated with the third subset of the input time-series data 109 is earlier at least in part to a fourth time range associated with the fourth subset of the input time-series data 109. The prediction accuracy of the time-series data predictor 140 can thus improve over time.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable medium or device having computer-readable program code (e.g., instructions) embodied or stored in the storage medium or device. Any suitable computer-readable medium or device may be utilized, including hard disks, CD-ROM, optical storage devices, magnetic storage devices, and/or other storage media. As used herein, a “computer-readable medium” or “computer-readable device” is not a signal.

Systems and methods may be described herein with reference to screen shots, block diagrams and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In conjunction with the described devices and techniques, an apparatus includes means for processing first input time-series data associated with a first time range using an embedding to generate an input embedding, the input embedding including a positional embedding and a temporal embedding, where the positional embedding indicates a position of an input value of the first input time-series data within the first input time-series data, and where the temporal embedding indicates that a first time associated with the input value is included in at least one of a particular day, a particular week, a particular month, a particular year, or a particular holiday. For example, the means for processing the first input time-series data may include the one or more pre-processing layers 103, the embedding generator 108, the time-series data predictor 140, the one or more processors 190, the device 102, the system 100 of FIG. 1, one or more devices or components configured to process the first input-time series data using an encoder, or any combination thereof.

The apparatus also includes means for processing the input embedding using a predictor to generate second predicted time-series data associated with a second time range, where the second time range is subsequent to at least a portion of the first time range. For example, the means for processing the input embedding may include the predictor 114, the time-series data predictor 140, the one or more processors 190, the device 102, the system 100 of FIG. 1, the encoder 710, the one or more encoding layers 750, the layer norm 752, the masked multi-head attention network 754, the layer norm 756, the feed forward 758, the one or more decoding layers 760, the layer norm 762, the masked multi-head attention network 764, the layer norm 766, the feed forward 768, the decoder 712 of FIG. 7, the multi-head attention network 864 of FIG. 8, one or more devices or components configured to process the input embedding using a predictor, or any combination thereof.

The apparatus further includes means for providing an output to a second device, the output based on the second predicted time-series data. For example, the means for providing the output may include the predictor 114, the time-series data predictor 140, the one or more processors 190, the device 102, the system 100 of FIG. 1, the residual generator 970, the risk scorer 980, the mode change detector 990, the system 900 of FIG. 9, one or more devices or components configured to provide the output to the second device, or any combination thereof.

Particular aspects of the disclosure are described below in the following clauses:

According to Clause 1, a device includes: one or more processors configured to: process first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday; process the input embedding using a predictor to generate second predicted time-series data associated with a second time range, wherein the second time range is subsequent to at least a portion of the first time range; and provide an output to a second device, the output based on the second predicted time-series data.

Clause 2 includes the device of Clause 1, wherein the one or more processors are further configured to: receive second input time-series data associated with the second time range; and detect, based on a comparison of second input time-series data and the second predicted time-series data, a change of operating mode of a monitored system.

Clause 3 includes the device of Clause 2, wherein the one or more processors are configured to generate an alert responsive to determining that the change of operating mode corresponds to an anomaly.

Clause 4 includes the device of Clause 2 or Clause 3, wherein the one or more processors are configured to, in response to determining that the change of operating mode corresponds to an anomaly, generate the output to indicate one or more features of the first input time-series data that have the greatest impact in determining the second predicted time-series data.

Clause 5 includes the device of any of Clause 1 to Clause 4, wherein the one or more processors are further configured to: receive second input time-series data associated with the second time range; determine residual data based on a comparison of the second input time-series data and the second predicted time-series data; determine a risk score based on the residual data; and based on determining that the risk score is greater than a threshold, generate an output indicating detection of a change of operating mode of a monitored system.

Clause 6 includes the device of any of Clause 1 to Clause 5, wherein the first input time-series data includes a plurality of sensor values generated during the first time range by a plurality of sensors.

Clause 7 includes the device of any of Clause 1 to Clause 6, wherein the embedding generator includes a batch normalization layer configured to apply normalization to a first batch of time-series data to generate a first batch of normalized time-series data, wherein the first batch of time-series data includes the first input time-series data, and wherein the first batch of normalized time-series data includes first normalized time-series data corresponding to the first input time-series data.

Clause 8 includes the device of Clause 7, wherein the embedding generator includes a spatial attention layer configured to apply first weights to the first normalized time-series data to generate first weighted time-series data.

Clause 9 includes the device of Clause 8, wherein a first batch of weighted time-series data includes a plurality of sequences of weighted time-series data, wherein a first sequence of weighted time-series data includes the first weighted time-series data, wherein the embedding generator includes a convolution layer configured to apply convolution weights to the first sequence of weighted time-series data to generate first convolved time-series data, and wherein the input embedding is based at least in part on the first convolved time-series data.

Clause 10 includes the device of any of Clause 1 to Clause 9, wherein the predictor includes: an encoder configured to process the input embedding to generate encoded data; and a decoder configured to process the encoded data to generate the second predicted time-series data.

Clause 11 includes the device of Clause 10, wherein the encoder comprises a first masked multi-head attention network, wherein an input to the first masked multi-head attention network is based on the input embedding, and wherein the encoded data is based on an output of the first masked multi-head attention network.

Clause 12 includes the device of Clause 10, wherein the encoder comprises a fourier transform layer, wherein an input to the fourier transform layer is based on the input embedding, and wherein the encoded data is based on an output of the fourier transform layer.

Clause 13 includes the device of any of Clause 10 to Clause 12, wherein the decoder is further configured to process the encoded data to generate predicted time-series data associated with multiple time ranges subsequent to the first time range, and wherein the multiple time ranges include the second time range.

Clause 14 includes the device of Clause 1, wherein the one or more processors are further configured to receive one or more input values of the first input time-series data from a sensor during the first time range, wherein the one or more input values include the input value, and wherein the position of the input value indicated by the positional embedding corresponds to a position of receipt of the input value relative to receipt of the one or more input values.

Clause 15 includes the device of Clause 14, wherein the input value is received from the sensor at the first time, and wherein the first time is included in the first time range.

Clause 16 includes the device of any of Clause 1 to Clause 15, wherein the decoder is further configured to process the encoded data to generate predicted time-series data associated with multiple time ranges subsequent to the first time range, and wherein the multiple time ranges include the second time range.

Clause 17 includes the device of any of Clause 1 to Clause 16, wherein the second device includes at least one of a display device, a storage device, or a controller of a monitored system.

Clause 18 includes the device of any of Clause 1 to Clause 17, further including: processing second input time-series data using the embedding generator to generate a second input embedding, the second input-time series data associated with the second time range; and processing the second input embedding using the predictor to generate third predicted time-series data associated with a third time range.

According to Clause 19, a method includes: processing first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday; processing the input embedding using a predictor to generate second predicted time-series data associated with a second time range; and providing an output to a second device, the output based on the second predicted time-series data.

Clause 20 includes the method of Clause 19, further including: receiving second input time-series data associated with the second time range; and detecting, based on a comparison of second input time-series data and the second predicted time-series data, a change of operating mode of a monitored system.

Clause 21 includes the method of Clause 20, further including generating an alert responsive to determining that the change of operating mode corresponds to an anomaly.

Clause 22 includes the method of Clause 20 or Clause 21, further including, in response to determining that the change of operating mode corresponds to an anomaly, generating the output to indicate one or more features of the first input time-series data that have the greatest impact in determining the second predicted time-series data.

Clause 23 includes the method of any of Clause 19 to Clause 22, further including: receiving second input time-series data associated with the second time range; determining residual data based on a comparison of the second input time-series data and the second predicted time-series data; determining a risk score based on the residual data; and based on determining that the risk score is greater than a threshold, generating an output indicating detection of a change of operating mode of a monitored system.

Clause 24 includes the method of any of Clause 19 to Clause 23, wherein the first input time-series data includes a plurality of sensor values generated during the first time range by a plurality of sensors.

Clause 25 includes the method of any of Clause 19 to Clause 24, further including: applying normalization to a first batch of time-series data to generate a first batch of normalized time-series data, wherein the first batch of time-series data includes the first input time-series data, and wherein the first batch of normalized time-series data includes first normalized time-series data corresponding to the first input time-series data.

Clause 26 includes the method of Clause 25, further including: applying, using a spatial attention layer of the embedding generator, first weights to the first normalized time-series data to generate first weighted time-series data.

Clause 27 includes the method of Clause 26, wherein a first batch of weighted time-series data includes a plurality of sequences of weighted time-series data, wherein a first sequence of weighted time-series data includes the first weighted time-series data, further including: applying, using a convolution layer of the embedding generator, convolution weights to the first sequence of weighted time-series data to generate first convolved time-series data, and wherein the input embedding is based at least in part on the first convolved time-series data.

Clause 28 includes the method of any of Clause 19 to Clause 27, further including: processing the input embedding using an encoder of the predictor to generate encoded data; and processing the encoded data using a decoder of the predictor to generate the second predicted time-series data.

Clause 29 includes the method of Clause 28, wherein an input to a first masked multi-head attention network of the encoder is based on the input embedding, and wherein the encoded data is based on an output of the first masked multi-head attention network.

Clause 30 includes the method of Clause 28, wherein an input to a fourier transform layer of the encoder is based on the input embedding, and wherein the encoded data is based on an output of the fourier transform layer.

Clause 31 includes the method of any of Clause 19 to Clause 30, further including: processing the encoded data using the decoder to generate predicted time-series data associated with multiple time ranges subsequent to the first time range, wherein the multiple time ranges include the second time range.

Clause 32 includes the method of any of Clause 19 to Clause 31, further including: receiving one or more input values of the first input time-series data from a sensor during the first time range, wherein the one or more input values include the input value, and wherein the position of the input value indicated by the positional embedding corresponds to a position of receipt of the input value relative to receipt of the one or more input values.

Clause 33 includes the method of Clause 32, wherein the input value is received from the sensor at the first time, and wherein the first time is included in the first time range.

Clause 34 includes the method of any of Clause 19 to Clause 33, further including: processing, using the predictor, the input embedding to generate predicted time-series data associated with multiple time ranges subsequent to the first time range, and wherein the multiple time ranges include the second time range.

Clause 35 includes the method of any of Clause 19 to Clause 34, wherein the second device includes at least one of a display device, a storage device, or a controller of a monitored system.

Clause 36 includes the method of any of Clause 19 to Clause 35, further including: processing second input time-series data using the embedding generator to generate a second input embedding, the second input time-series data associated with the second time range; and processing the second input embedding using the predictor to generate third predicted time-series data associated with a third time range.

According to Clause 37, a non-transitory computer-readable medium stores instructions that, when executed by a processor, cause the processor to perform the method of any of Clause 19 to Clause 36.

According to Clause 38, an apparatus includes means for carrying out the method of any of Clause 19 to Clause 36.

According to Clause 39, a non-transitory computer-readable medium stores instructions that, when executed by one or more processors, cause the one or more processors to: process first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday; process the input embedding using a predictor to generate second predicted time-series data associated with a second time range; and provide an output to a second device, the output based on the second predicted time-series data.

Clause 40 includes the non-transitory computer-readable medium of Clause 39, wherein the instructions, when executed by the one or more processors, also cause the one or more processors to: receive second input time-series data associated with the second time range; and detect, based on a comparison of the second input time-series data and the second predicted time-series data, a change of operating mode of a monitored system.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more processors configured to:
process first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday;
process the input embedding using a predictor to generate second predicted time-series data associated with a second time range, wherein the second time range is subsequent to at least a portion of the first time range; and
provide an output to a second device, the output based on the second predicted time-series data.

2. The device of claim 1, wherein the one or more processors are further configured to:
receive second input time-series data associated with the second time range; and
detect, based on a comparison of second input time-series data and the second predicted time-series data, a change of operating mode of a monitored system.

3. The device of claim 2, wherein the one or more processors are configured to generate an alert responsive to determining that the change of operating mode corresponds to an anomaly.

4. The device of claim 2, wherein the one or more processors are configured to, in response to determining that the change of operating mode corresponds to an anomaly, generate the output to indicate one or more features of the first input time-series data that have the greatest impact in determining the second predicted time-series data.

5. The device of claim 1, wherein the one or more processors are further configured to:
receive second input time-series data associated with the second time range;
determine residual data based on a comparison of the second input time-series data and the second predicted time-series data;
determine a risk score based on the residual data; and
based on determining that the risk score is greater than a threshold, generate an output indicating detection of a change of operating mode of a monitored system.

6. The device of claim 1, wherein the first input time-series data includes a plurality of sensor values generated during the first time range by a plurality of sensors.

7. The device of claim 1, wherein the embedding generator includes a batch normalization layer configured to apply normalization to a first batch of time-series data to generate a first batch of normalized time-series data, wherein the first batch of time-series data includes the first input time-series data, and wherein the first batch of normalized time-series data includes first normalized time-series data corresponding to the first input time-series data.

8. The device of claim 7, wherein the embedding generator includes a spatial attention layer configured to apply first weights to the first normalized time-series data to generate first weighted time-series data.

9. The device of claim 8, wherein a first batch of weighted time-series data includes a plurality of sequences of weighted time-series data, wherein a first sequence of weighted time-series data includes the first weighted time-series data, wherein the embedding generator includes a convolution layer configured to apply convolution weights to the first sequence of weighted time-series data to generate first convolved time-series data, and wherein the input embedding is based at least in part on the first convolved time-series data.

10. The device of claim 1, wherein the predictor includes:
an encoder configured to process the input embedding to generate encoded data; and
a decoder configured to process the encoded data to generate the second predicted time-series data.

11. The device of claim 10, wherein the encoder comprises a first masked multi-head attention network, wherein an input to the first masked multi-head attention network is based on the input embedding, and wherein the encoded data is based on an output of the first masked multi-head attention network.

12. The device of claim 10, wherein the encoder comprises a fourier transform layer, wherein an input to the fourier transform layer is based on the input embedding, and wherein the encoded data is based on an output of the fourier transform layer.

13. The device of claim 10, wherein the decoder is further configured to process the encoded data to generate predicted time-series data associated with multiple time ranges subsequent to the first time range, and wherein the multiple time ranges include the second time range.

14. The device of claim 1, wherein the one or more processors are further configured to receive one or more input values of the first input time-series data from a sensor during the first time range, wherein the one or more input values include the input value, and wherein the position of the input value indicated by the positional embedding corresponds to a position of receipt of the input value relative to receipt of the one or more input values.

15. The device of claim 14, wherein the input value is received from the sensor at the first time, and wherein the first time is included in the first time range.

16. The device of claim 1, wherein the predictor is further configured to process the input embedding to generate predicted time-series data associated with multiple time ranges subsequent to the first time range, and wherein the multiple time ranges include the second time range.

17. The device of claim 1, wherein the second device includes at least one of a display device, a storage device, or a controller of a monitored system.

18. A method comprising:
processing first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday;
processing the input embedding using a predictor to generate second predicted time-series data associated with a second time range; and
providing an output to a second device, the output based on the second predicted time-series data.

19. The method of claim 18, further comprising:
processing second input time-series data using the embedding generator to generate a second input embedding, the second input time-series data associated with the second time range; and
processing the second input embedding using the predictor to generate third predicted time-series data associated with a third time range.

20. A non-transitory computer-readable medium storing instructions that, when executed by one or more processors, cause the one or more processors to:
process first input time-series data associated with a first time range using an embedding generator to generate an input embedding, the input embedding including a positional embedding and a temporal embedding, wherein the positional embedding indicates a position of an input value of the first input time-series data within the first input time-series data, and wherein the temporal embedding indicates that a first time associated with the input value is included in at least one of a particular day, a particular week, a particular month, a particular year, or a particular holiday;
process the input embedding using a predictor to generate second predicted time-series data associated with a second time range; and
provide an output to a second device, the output based on the second predicted time-series data.
